(19) United States
(12) Patent Application Publication
(10) Pub. No.: US 2021/0256403 A1
(43) Pub. Date: Aug. 19, 2021

(54) RECOMMENDATION METHOD AND APPARATUS

(71) Applicant: HUAWEI TECHNOLOGIES CO., LTD., Shenzhen (CN)

(72) Inventors: Ruiming Tang, Shenzhen (CN); Qing Liu, Shenzhen (CN); Yuzhou Zhang, Shenzhen (CN); Li Qian, Shenzhen (CN); Haokun Chen, Shanghai (CN); Weinan Zhang, Shanghai (CN); Yong Yu, Shanghai (CN)

(73) Assignee: HUAWEI TECHNOLOGIES CO., LTD., Shenzhen (CN)

(21) Appl. No.: 17/313,383

(22) Filed: May 6, 2021

Related U.S. Application Data
(63) Continuation of application No. PCT/CN2019/116003, filed on Nov. 6, 2019.

(30) Foreign Application Priority Data
Nov. 9, 2018 (CN) 201811337589.9

(51) Int. Cl. G06N 5/04; G06N 3/04; G06K 9/62

(52) U.S. Cl. CPC G06N 5/04; G06K 9/6219; G06N 3/049

(57) ABSTRACT

In a recommendation-providing method in the field of artificial intelligence, an apparatus for generating recommendations obtains a recommendation system status parameter based on a plurality of historical recommended objects and a user behavior for each historical recommended object, such as clicks or downloads. The apparatus determines a target set among lower-level sets according to the recommendation system status parameter and a selection policy corresponding to an upper-level set, where the lower-level sets and upper-level set correspond to nodes on a clustering tree representing available to-be-presented objects, and each set corresponds to one selection policy. The apparatus then determines a target to-be-recommended object from the to-be recommended objects in the target set.

### CROSS-REFERENCE TO RELATED APPLICATIONS

This application is a continuation of International Application No. PCT/CN2019/116003, filed on Nov. 6, 2019, which claims priority to Chinese Patent Application No. 201811337589.9, filed on Nov. 9, 2018. The disclosures of the aforementioned priority applications are hereby incorporated by reference in their entirety.

### TECHNICAL FIELD

The present invention relates to the field of artificial intelligence, and in particular, to a recommendation method and apparatus.

### BACKGROUND

Recommendation and search are one of important research interests in the field of artificial intelligence. A most important construction objective of a personalized recommendation system is to accurately predict a user requirement or preference for a specific item and make a corresponding recommendation to a user based on a determining result. This not only affects user experience, but also directly affects benefits of a related enterprise product, such as use frequency or downloads and clicks. Therefore, prediction of a user behavioral requirement or preference is of great significance. Currently, basic and mainstream prediction methods are all based on a recommendation system model of supervised learning (supervised learning). Main problems of a recommendation system modeled based on supervised learning are as follows: (1) In supervised learning, a recommendation process is considered as a static prediction process, where interests and hobbies of a user do not change with time. However, actually, recommendation should be a dynamic sequence decision-making process, and interests and hobbies of a user may change with time. (2) Supervised learning maximizes an instant reward of a recommendation result, such as a click-through rate. However, in many cases, items with relatively small instant rewards but large future rewards should also be considered.

In recent years, reinforcement learning has made great breakthroughs in many dynamic interaction and long-term planning scenarios, such as unmanned driving and games. Conventional reinforcement learning methods include a value-based method and a policy-based method. In a learning recommendation system of the value-based reinforcement learning method, a Q function is first obtained through training and learning; then, Q values of all to-be-recommended action objects are calculated based on a current status; and finally, during recommendation, an action object with a largest Q value is selected for recommendation. In a learning recommendation system of the policy-based reinforcement learning method, a policy function is first obtained through training and learning, and then, an optimal action object is determined according to a policy and based on a current status, for recommendation. In both the learning recommendation system of the value-based reinforcement learning method and the learning recommendation system of the policy-based reinforcement learning method, for recommendation, all to-be-recommended action objects need to be traversed, and a related probability value of each to-be-recommended object needs to be calculated. This is very time consuming, and efficiency is low.

### SUMMARY

Embodiments of the present invention provide a recommendation method and apparatus, to help improve recommendation efficiency.

According to a first aspect, an embodiment of the present invention provides a recommendation method, including:

obtaining a recommendation system status parameter based on a plurality of historical recommended objects and a user behavior for each historical recommended object; determining a target set in lower-level sets from the lower-level sets based on the recommendation system status parameter and according to a selection policy corresponding to an upper-level set, where the upper-level set and the lower-level sets are obtained by performing hierarchical clustering on a plurality of to-be-recommended objects, the hierarchical clustering is grouping the to-be-recommended objects into a plurality of levels of sets, and the upper-level set includes a plurality of lower-level sets; and determining a target to-be-recommended object from the target set. The plurality of to-be-recommended objects are grouped into the plurality of sets in a hierarchical clustering manner, and then the target to-be-recommended object is selected from the target set that is determined from the plurality of sets based on the recommendation system status parameter and according to the selection policy. This improves recommendation efficiency and accuracy.

In a possible embodiment, the obtaining a recommendation system status parameter based on a plurality of historical recommended objects and a user behavior for each historical recommended object includes: determining a reward value of each historical recommended object based on the user behavior for the historical recommended object; and inputting the plurality of historical recommended objects and reward values of the plurality of historical recommended objects into a status generation model, to obtain the recommendation system status parameter, where the status generation model is a recurrent neural network model.

In a possible embodiment, the target set in the lower-level sets corresponds to one selection policy, the target set in the lower-level sets includes a plurality of subsets, the subset is a lower-level set of the target set, and the determining a target to-be-recommended object from the target set includes:

selecting, based on the recommendation system status parameter and according to the selection policy corresponding to the target set, a target subset from the plurality of subsets included in the target set; and determining the target to-be-recommended object from the target subset. The plurality of to-be-recommended objects are grouped into smaller sets, and then the target to-be-recommended object is determined from the set. This further improves recommendation efficiency and accuracy.

In a possible embodiment, each lower-level set corresponds to one selection policy, and the determining a target to-be-recommended object from the target set includes: selecting the target to-be-recommended object from the target set according to a selection policy corresponding to the target set and based on the recommendation system status parameter.

In a possible embodiment, the performing hierarchical clustering on a plurality of to-be-recommended objects includes: performing hierarchical clustering on the plurality of to-be-recommended objects by constructing a balanced clustering tree.

In a possible embodiment, the selection policy is a fully connected neural network model.

In a possible embodiment, the selection policy and the status generation model are obtained through machine learning and training, and training sample data is (s₁, a₁, r₁, s₂, a₂, r₂, . . . , sₜ, aₜ, rₜ), where (a₁, a₂, . . . , aₜ) are historical recommended objects; r₁, r₂, . . . , and rₜ are reward values obtained through calculation based on user behaviors for the historical recommended objects (a₁, a₂, . . . , aₜ), respectively; and (s₁, s₂, . . . , sₜ) are historical recommendation system status parameters.

In a possible embodiment, after the determining a target to-be-recommended object, the method further includes: obtaining a user behavior for the target to-be-recommended object;

and using the target to-be-recommended object and the user behavior for the target to-be-recommended object as historical data to determine a next to-be-recommended object.

According to a second aspect, an embodiment of the present invention provides a recommendation apparatus, including:

a status generation module, configured to obtain a recommendation system status parameter based on a plurality of historical recommended objects and a user behavior for each historical recommended object; and

an action generation module, configured to determine a target set in lower-level sets from the lower-level sets based on the recommendation system status parameter and according to a selection policy corresponding to an upper-level set, where the upper-level set and the lower-level sets are obtained by performing hierarchical clustering on a plurality of to-be-recommended objects, the hierarchical clustering is grouping the to-be-recommended objects into a plurality of levels of sets, and the upper-level set includes a plurality of lower-level sets.

The action generation module is further configured to determine a target to-be-recommended object from the target set.

In a possible embodiment, the status generation module is specifically configured to: determine a reward value of each historical recommended object based on the user behavior for the historical recommended object; and input the plurality of historical recommended objects and reward values of the plurality of historical recommended objects into a status generation model, to obtain the recommendation system status parameter, where the status generation model is a recurrent neural network model.

In a possible embodiment, the target set in the lower-level sets corresponds to one selection policy, the target set in the lower-level sets includes a plurality of subsets, the subset is a lower-level set of the target set, and in terms of the determining a target to-be-recommended object from the target set, the action generation module is specifically configured to:

select, based on the recommendation system status parameter and according to the selection policy corresponding to the target set, a target subset from the plurality of subsets included in the target set; and determine the target to-be-recommended object from the target subset.

In a possible embodiment, each lower-level set corresponds to one selection policy, and in terms of the determining a target to-be-recommended object from the target set, the action generation module is specifically configured to:

select the target to-be-recommended object from the target set according to a selection policy corresponding to the target set and based on the recommendation system status parameter.

In a possible embodiment, the performing hierarchical clustering on a plurality of to-be-recommended objects includes: performing hierarchical clustering on the plurality of to-be-recommended objects by constructing a balanced clustering tree.

In a possible embodiment, the selection policy is a fully connected neural network model.

In a possible embodiment, the selection policy and the status generation model are obtained through machine learning and training, and training sample data is (s₁, a₁, r₁, s₂, a₂, r₂, . . . , sₜ, aₜ, rₜ), where (a₁, a₂, . . . , aₜ) are historical recommended objects; r₁, r₂, . . . , and rₜ are reward values obtained through calculation based on user behaviors for the historical recommended objects (a₁, a₂, . . . , aₜ), respectively; and (s₁, s₂, . . . , sₜ) are historical recommendation system status parameters.

In a possible embodiment, the recommendation apparatus further includes:

an obtaining module, configured to obtain a user behavior for the target to-be-recommended object after the target to-be-recommended object is determined.

The status generation module and the action generation module are further configured to use the target to-be-recommended object and the user behavior for the target to-be-recommended object as historical data to determine a next to-be-recommended object.

According to a third aspect, an embodiment of the present invention provides another recommendation apparatus, including:

a memory, configured to store an instruction; and

at least one processor, coupled to the memory.

When the at least one processor executes the instruction, the instruction enables the processor to perform the following steps: obtaining a recommendation system status parameter based on a plurality of historical recommended objects and a user behavior for each historical recommended object; determining a target set in lower-level sets from the lower-level sets based on the recommendation system status parameter and according to a selection policy corresponding to an upper-level set, where the upper-level set and the lower-level sets are obtained by performing hierarchical clustering on a plurality of to-be-recommended objects, the hierarchical clustering is grouping the to-be-recommended objects into a plurality of levels of sets, and the upper-level set includes a plurality of lower-level sets; and determining a target to-be-recommended object from the target set.

In a possible embodiment, when performing the step of obtaining a recommendation system status parameter based on a plurality of historical recommended objects and a user behavior for each historical recommended object, the processor specifically performs the following steps:

determining a reward value of each historical recommended object based on the user behavior for the historical recommended object; and inputting the plurality of historical recommended objects and reward values of the plurality of historical recommended objects into a status generation model, to obtain the recommendation system status parameter, where the status generation model is a recurrent neural network model.

In a possible embodiment, the target set in the lower-level sets corresponds to one selection policy, the target set in the lower-level sets includes a plurality of subsets, the subset is a lower-level set of the target set, and when performing the step of determining a target to-be-recommended object from the target set, the processor specifically performs the following steps:

selecting, based on the recommendation system status parameter and according to the selection policy corresponding to the target set, a target subset from the plurality of subsets included in the target set; and determining the target to-be-recommended object from the target subset.

In a possible embodiment, each lower-level set corresponds to one selection policy, and when performing the step of determining a target to-be-recommended object from the target set, the processor specifically performs the following step:

selecting the target to-be-recommended object from the target set according to a selection policy corresponding to the target set and based on the recommendation system status parameter.

In a possible embodiment, the performing hierarchical clustering on a plurality of to-be-recommended objects includes: performing hierarchical clustering on the plurality of to-be-recommended objects by constructing a balanced clustering tree.

In a possible embodiment, the selection policy is a fully connected neural network model.

In a possible embodiment, the selection policy and the status generation model are obtained through machine learning and training, and training sample data is (s₁, a₁, r₁, s₂, a₂, r₂, . . . , sₜ, aₜ, rₜ), where (a₁, a₂, . . . , aₜ) are historical recommended objects; r₁, r₂, . . . , and rₜ are reward values obtained through calculation based on user behaviors for the historical recommended objects (a₁, a₂, . . . , aₜ), respectively; and (s₁, s₂, . . . , sₜ) are historical recommendation system status parameters.

In a possible embodiment, after determining the target to-be-recommended object, the processor specifically performs the following steps:

obtaining a user behavior for the target to-be-recommended object; and using the target to-be-recommended object and the user behavior for the target to-be-recommended object as historical data to determine a next to-be-recommended object.

According to a fourth aspect, an embodiment of the present invention provides a computer storage medium, where the computer storage medium stores a computer program, the computer program includes a program instruction, and when the program instruction is executed by a processor, the processor is enabled to perform some or all methods according to the first aspect.

It can be learned that, in the solutions in the embodiments of the present invention, the recommendation system status parameter is obtained based on the plurality of historical recommended objects and the user behavior for each historical recommended object; the target set in the lower-level sets is determined from the lower-level sets based on the recommendation system status parameter and according to the selection policy corresponding to the upper-level set, where the upper-level set and the lower-level sets are obtained by performing hierarchical clustering on the plurality of to-be-recommended objects, the hierarchical clustering is grouping the to-be-recommended objects into the plurality of levels of sets, and the upper-level set includes the plurality of lower-level sets; and the target to-be-recommended object is determined from the target set. The embodiments of the present invention help improve efficiency and accuracy of obj ect recommendation.

These aspects or other aspects of the present invention are clearer and more comprehensible in descriptions of the following embodiments.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following descriptions show merely some embodiments of the present invention, and a person of ordinary skill in the art may derive other drawings from these accompanying drawings without creative efforts.

FIG. 1 is a schematic diagram of a framework of a recommendation system based on reinforcement learning according to an embodiment of the present invention;

FIG. 2 is a schematic flowchart of an interactive recommendation method according to an embodiment of the present invention;

FIG. 3 is a schematic diagram of a process of generating a recommendation system status parameter according to an embodiment of the present invention;

FIG. 4 is a schematic diagram of a process of generating a recommendation system status parameter according to an embodiment of the present invention;

FIG. 5 is a schematic diagram of a recommendation process according to an embodiment of the present invention;

FIG. 6 is a schematic diagram of another recommendation process according to an embodiment of the present invention;

FIG. 7 is a schematic diagram of a balanced clustering tree according to an embodiment of the present invention;

FIG. 8 is a schematic diagram of still another recommendation process according to an embodiment of the present invention;

FIG. 9 is a schematic diagram of a balanced clustering tree according to an embodiment of the present invention;

FIG. 10 is a schematic diagram of yet another recommendation process according to an embodiment of the present invention;

FIG. 11 is a schematic structural diagram of a recommendation apparatus according to an embodiment of the present invention;

FIG. 12 is a schematic structural diagram of another recommendation apparatus or a training apparatus according to an embodiment of the present invention;

FIG. 13 is a schematic structural diagram of still another recommendation apparatus according to an embodiment of the present invention; and

FIG. 14 is a schematic diagram of a system architecture according to an embodiment of the present invention.

### DESCRIPTION OF EMBODIMENTS

The following describes the embodiments of this application with reference to the accompanying drawings.

First, a working principle of a recommendation method based on reinforcement learning is described. After receiving a request triggered by a user, a recommendation system based on reinforcement learning generates a recommendation system status parameter (sₜ) based on the request and corresponding information, determines a recommended object (for example, a to-be-recommended item) based on the recommendation system status parameter, and sends the selected recommended object to the user. After receiving the recommended object, the user performs a specific behavior (such as click or download) on the recommended object. The recommendation system generates a value based on the behavior performed by the user. The value is referred to as a system reward value. The recommendation system generates a next recommendation system status parameter (sₜ₊₁) based on the reward value and the recommended object, and then jumps from the current recommendation system status parameter (sₜ) to the next recommendation system status parameter (sₜ₊₁). This process is repeated, so that a final system recommendation result increasingly meets a user requirement.

The recommendation method in the embodiments of the present invention may be applied to various different application scenarios, for example, a mobile phone application market, content recommendation on a content platform, unmanned driving, and a game. App recommendation in the mobile phone application market is first used as an example for description. When a user opens the mobile phone application market, the application market is triggered to recommend an application to the user, and the application market recommends one application or a group of applications (that is, a recommended object) to the user based on a historical user behavior such as download or click and characteristic information such as characteristics of the user and the application (that is, a recommendation system status parameter). The characteristics of the application include characteristics such as an application type, developer information, and development duration. The user performs a specific behavior on the application recommended by the application market. A reward value is obtained based on the user behavior. A reward is defined based on a specific application scenario. For example, in the mobile phone application market, the reward value may be defined as downloads, clicks, an amount paid by the user in an application, or the like. An objective of the application market is to enable, through reinforcement learning, an application recommended by the system to increasingly meet a user requirement, and to increase benefits of the application market.

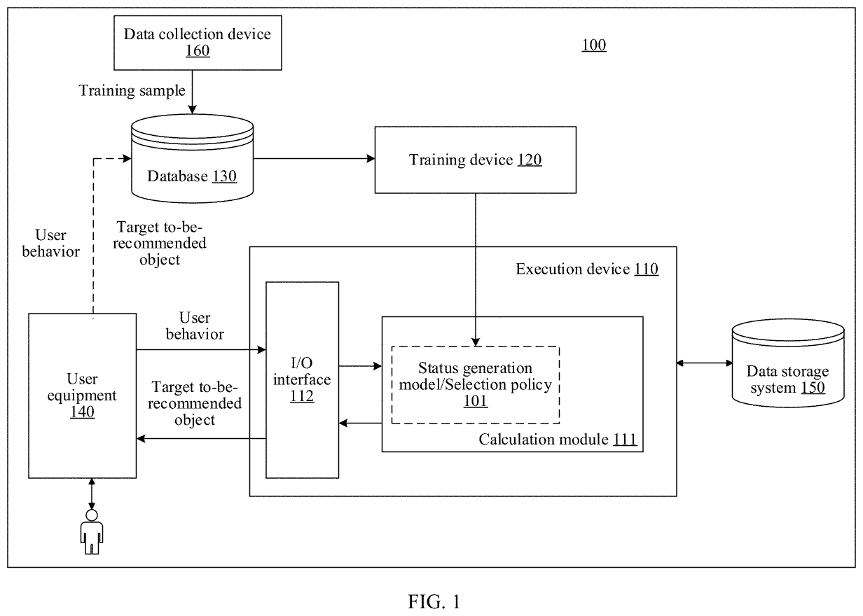

Referring to FIG. 1, an embodiment of the present invention provides a recommendation system architecture 100. A data collection device 160 is configured to collect a plurality of pieces of training sample data from a network and store the training sample data into a database 130. A training device 120 generates a status generation model/selection policy 101 based on the training sample data maintained in the database 130. The following describes in further detail how the training device 120 obtains the status generation model/selection policy 101 based on the training sample data. The status generation model in the status generation model/selection policy 101 may be used to determine a recommendation system status parameter based on a plurality of historical recommended objects and a user behavior for each historical recommended object. Then, the selection policy is used to determine, from a plurality of to-be-recommended objects based on the recommendation system status parameter, a target to-be-recommended object to be recommended to a user.

Model training in this embodiment of the present invention may be implemented by using a neural network, for example, a fully connected neural network or a deep neural network. Work of each layer in the deep neural network may be described by using a mathematical expression \vec{y}=a(W x \vec{x}+b). W represents a weight, \vec{x} represents an input vector (that is, an input neuron), b represents offset data, \vec{y} represents an output vector (that is, an output neuron), and a represents a constant. Physically, the work of each layer in the deep neural network may be understood as implementing transformation from input space to output space (that is, from row space to column space of a matrix) by performing five operations on the input space (a set of input vectors). The five operations include: 1. dimension raising/dimension reduction; 2. scaling out/scaling in; 3. rotation; 4. translation; and 5. “bending”. The operations 1, 2, and 3 are implemented by W x \vec{x}, the operation 4 is implemented by (+b), and the operation 5 is implemented by a( ). A reason of using the word “space” herein for description is that a classified object is not a single object, but a type of object. The space refers to a set of all individuals of this type of object. W represents a weight vector, and each value in the vector represents a weight value of one neuron in a neural network at this layer. The vector W determines spatial transformation from the input space to the output space described above. In other words, a weight W of each layer controls how to transform space. The deep neural network is trained to finally obtain a weight matrix (a weight matrix constituted by vectors W of many layers) of all layers of a trained neural network. Therefore, a process of training the deep neural network is essentially learning a spatial transformation control manner, and more specifically, learning a weight matrix.

It is expected that an output of the deep neural network shall be close, as much as possible, to a predicted value that is actually expected. Therefore, a predicted value of a current network and an actually expected target value may be compared, and then a weight vector of each layer of neural network is updated based on a difference between the two values (certainly, there is usually an initialization process before the first update, to be specific, a parameter is preconfigured for each layer in the deep neural network). For example, if a predicted value for the network is large, the weight vector is adjusted to make the predicted value smaller. Such adjustment is constantly performed until the neural network can obtain the actually expected target value through prediction. Therefore, “how to obtain, through comparison, a difference between a predicted value and a target value” needs to be predefined. This is a loss function (loss function) or an objective function (objective function). The loss function and the objective function are important equations used to measure a difference between a predicted value and a target value. The loss function is used as an example. A larger output value (loss) of the loss function indicates a larger difference, and therefore, training of the deep neural network is a process of reducing the loss as much as possible.

The status generation model/selection policy 101 obtained by the training device 120 may be applied to different systems or devices. In FIG. 1, an execution device 110 is disposed with an I/O interface 112, to perform data interaction with an external device, for example, send the target to-be-recommended object to user equipment 140. The “user” may input, to the I/O interface 112 by using the user equipment 140, a user behavior of the user for the target to-be-recommended object.

The execution device 110 may invoke the to-be-recommended objects, the historical recommended objects, and user behaviors for the historical recommended objects that are stored in a data storage system 150, to determine the target to-be-recommended object, and may also store the target to-be-recommended object and the user behavior for the target to-be-recommended object into the data storage system 150.

A calculation module 111 performs recommendation by using the status generation model/selection policy 101. Specifically, after obtaining the plurality of historical recommended objects and the user behavior for each historical recommended object, the calculation module 111 determines the recommendation system status parameter for the plurality of historical recommended objects and the user behavior for each historical recommended object by using the status generation model, and then inputs the recommendation system status parameter into the selection policy for processing, to obtain the target to-be-recommended object.

Finally, the I/O interface 112 returns the target to-be-recommended object to the user equipment 140, to provide the target to-be-recommended object for the user.

More deeply, the training device 120 may generate, for different targets, corresponding status generation models/selection policies 101 based on different data, to provide a better result for the user.

In the case shown in FIG. 1, the user may view, on the user equipment 140, the target to-be-recommended object output by the execution device 110. A specific presentation form may be a specific manner such as display, a sound, or an action. The user equipment 140 may also serve as a data collection end to store the collected training sample data in the database 130.

It should be noted that FIG. 1 is merely a schematic diagram of the system architecture provided in this embodiment of the present invention, and location relationships between devices, components, modules, and the like shown in the figure do not constitute any limitation. For example, in FIG. 1, the data storage system 150 is an external storage relative to the execution device 110. In another case, the data storage system 150 may be disposed in the execution device 110.

The training device 120 obtains, from the database 130, recommendation information of one or more episodes obtained through sampling, and trains the status generation model/selection policy 101 based on the recommendation information of one or more episodes.

In a possible embodiment, the status generation model and the selection policy are trained offline. In other words, the training device 120 and the database are independent of the user equipment 140 and the execution device 110. For example, the training device 120 is a third-party server. Before the execution device 110 works, the status generation model and the selection policy are obtained from the third-party server.

In a possible embodiment, the training device 120 is integrated with the execution device 110, and the execution device 110 is disposed in the user equipment 140.

After obtaining the status generation model and the selection policy, the execution device 110 obtains the plurality of historical recommended objects and the user behavior for each historical recommended object from the data storage system 150; calculates a reward value of each historical recommended object based on the user behavior for each historical recommended object;

processes the plurality of historical recommended objects and a user reward for each historical recommended object by using the status generation model, to generate a recommendation system status parameter; and then processes the recommendation system status parameter by using the selection policy, to obtain the target to-be-recommended object to be recommended to the user. The user gives a feedback (that is, a user behavior) for the target to-be-recommended object. The user behavior is stored into the database 130, or may be stored into the data storage system 150 by the execution device 110, for performing a next to-be-recommended object.

In a possible embodiment, the recommendation system architecture includes only the database 130, and does not include the data storage system 150. After the user equipment 140 receives the target to-be-recommended object that is output by the execution device 110 through the I/O interface 112, the user equipment 140 stores the target to-be-recommended object and the user behavior for the target to-be-recommended object into the database 130, to train the status generation model/selection policy 101.

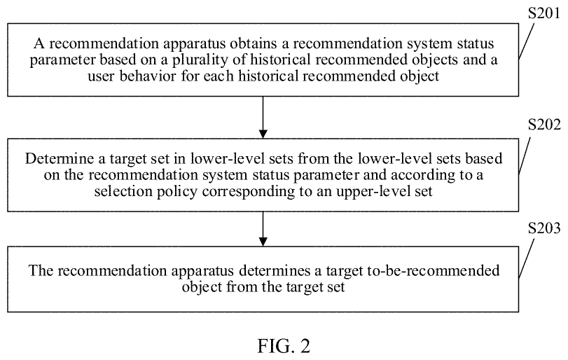

FIG. 2 is a schematic flowchart of a recommendation method according to an embodiment of the present invention. As shown in FIG. 2, the method includes the following steps.

S201: A recommendation apparatus obtains a recommendation system status parameter based on a plurality of historical recommended objects and a user behavior for each historical recommended object.

Before obtaining the recommendation system status parameter based on the plurality of historical recommended objects and the user behavior for each historical recommended object, the recommendation apparatus obtains the plurality of historical recommended objects and the user behavior for each historical recommended object from a log database.

It should be noted that the log database may be the database 130 shown in FIG. 1, or may be the data storage system 150 shown in FIG. 1.

Further, that a recommendation apparatus obtains a recommendation system status parameter based on a plurality of historical recommended objects and a user behavior for each historical recommended object includes:

determining a reward value of each historical recommended object based on the user behavior for the historical recommended object; and

inputting the plurality of historical recommended objects and the reward value of each historical recommended object into the status generation model, to obtain the recommendation system status parameter.

The reward value of each historical recommended object is determined based on the user behavior for the historical recommended object. The reward value is a value related to the user behavior, and may be defined in a plurality of manners. For example, an application is recommended to a user, and if the user downloads the application, a reward of the application is 1, or if the user does not download the application, a reward of the application is 0. For another example, an article is recommended to a user, and if the user clicks and reads the article, a reward of the article is 1, or if the user does not click or read the article, a reward of the article is 0.

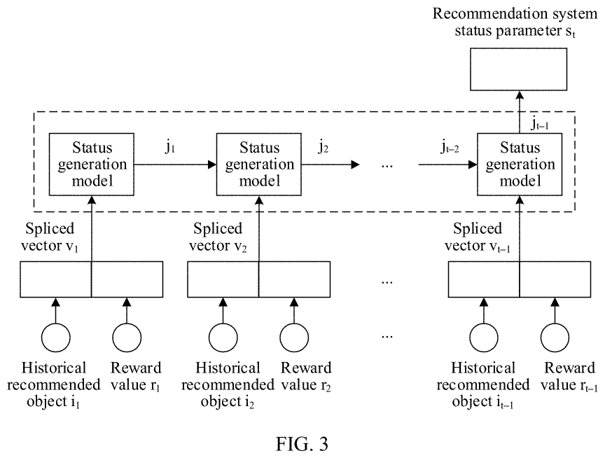

Specifically, FIG. 3 is a schematic diagram of a process of generating a recommendation system status parameter according to an embodiment of the present invention. As shown in FIG. 3, the recommendation apparatus obtains t−1 historical recommended objects and corresponding reward values of the t−1 historical recommended objects (that is, reward values of the t−1 historical recommended objects). The recommendation apparatus performs vector mapping on the t−1 historical recommended objects (that is, historical recommended objects i₂, . . . , and iₜ₋₁) and reward values (that is, reward values r₁, r₂, . . . , and rₜ₋₁) of the t−1 historical recommended objects, to obtain t−1 historical recommended object vectors and t−1 reward vectors. The t−1 historical recommended object vectors one-to-one correspond to the t−1 reward vectors.

It should be noted that the historical recommended objects i ₁, i₂, and iₜ₋₁ are respectively the first, the second, and the (t−1)^{th} historical recommended objects in the t−1 historical recommended objects, and the reward values r₁, r₂, and rₜ₋₁ are respectively the first, the second, and the (t−1)^{th} reward values in the t−1 reward values.

The recommendation apparatus splices the t−1 historical recommended object vectors and the corresponding reward vectors of the t−1 historical recommended object vectors, to obtain t−1 spliced vectors (that is, spliced vectors v₁, v₂, . . . , and vₜ₋₁). Then, the recommendation apparatus inputs the first spliced vector v₁ in the t−1 spliced vectors into the status generation model for an operation, to obtain a calculation result j₁; inputs the calculation result j₁ and the second spliced vector v₂ in the t−1 spliced vectors into the status generation model, to obtain a calculation result j₂; and then inputs the calculation result j₂ and the third spliced vector in the t−1 spliced vectors into the status generation model, to obtain a calculation result j₃. By analogy, the recommendation apparatus inputs a calculation result jₜ₋₂ and the last spliced vector vₜ₋₁ in the t−1 spliced vectors into the status generation model, to obtain a calculation result jₜ₋₁. The calculation result jₜ₋₁ is the recommendation system status parameter sₜ.

An example is used to describe a process of splicing historical recommended object vectors and corresponding reward vectors of the historical recommended object vectors. It is assumed that there are three historical recommended objects, mapping vectors of the three historical recommended objects are respectively (0, 0, 1), (0, 1, 0), and (1, 0, 0), and reward vectors corresponding to reward values of the three historical recommended objects are respectively (3, 0), (4, 1), and (5, 6). In this case, a result v₁ obtained by splicing a vector of the first historical recommended object in the three historical recommended objects and a corresponding reward vector of the first historical recommended object is (0, 0, 1, 3, 0); a result v₂ obtained by splicing a vector of the second historical recommended object in the three historical recommended objects and a corresponding reward vector of the second historical recommended object is (0, 1, 0, 4, 1); and a result v₃ obtained by splicing a vector of the third historical recommended object in the three historical recommended objects and a corresponding reward vector of the third historical recommended object is (1, 0, 0, 5, 6).

It should be noted that the calculation results j₁, j₂, j₃, . . . , and jₜ₋₁ are all vectors.

The term “vector” mentioned in this specification corresponds to any information that is associated with a corresponding vector dimension and that has two or more elements.

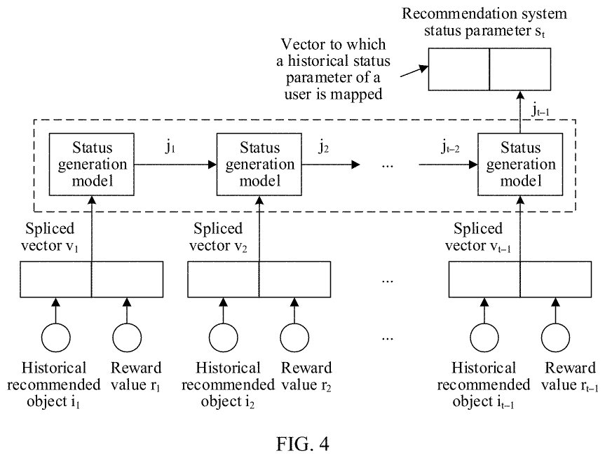

In a possible embodiment, after obtaining the plurality of historical recommended objects and the reward value of each historical recommended object, the recommendation apparatus further obtains a historical status parameter of the user, where the historical status parameter of the user is a statistical value of a historical behavior of the user. Referring to FIG. 4, after obtaining the calculation result jₜ₋₁ according to the foregoing method, the recommendation apparatus splices the calculation result jₜ₋₁ and a vector to which the historical status parameter of the user is mapped, to obtain the recommendation system status parameter sₜ.

It should be noted that the historical status parameter of the user (that is, statistical information of the historical behavior of the user) includes any one or any combination of a positive feedback (such as a positive review or a high score) and a negative feedback (such as a negative review or a low score) given by the user for a recommended object and a quantity of consecutive positive feedbacks or negative feedbacks given by the user for the recommended object within a period of time.

For example, assuming that there are eight historical recommended objects, the recommendation apparatus first maps the eight historical recommended objects to vectors, for example, maps each of the eight historical recommended objects to a vector whose length is 3, and the vectors may be represented as (0, 0, 0), (0, 0, 1), (0, 1, 0), (0, 1, 1), (1, 0, 0), (1, 0, 1), (1, 1, 0), and (1, 1, 1). There are a plurality of vector representation methods. The vectors may be obtained through pre-training, or may be obtained through training together with a selection policy.

It should be noted that a model used for mapping the historical recommended objects to vectors through pre-training may be a matrix factorization model.

Each user reward for the historical recommended object is also encoded into a vector. Assuming that a value range of the user reward for the historical recommended object is (a, b], the range is divided into m intervals, to be specific, a reward value of the user for the historical recommended object is encoded into a vector whose length is m, and m elements included in the vector one-to-one correspond to the m intervals, where m is an integer greater than 1. The recommendation apparatus sets, to 1, an element value corresponding to an interval to which the reward value of the user for the historical recommended object belongs, and sets an element value corresponding to another interval to 0. It is assumed that the value range of the user reward for the historical recommended object is (0, 2], and the recommendation apparatus divides the value range into two intervals (0, 1] and (1, 2]. In this case, a reward value 1.5 for the historical recommended object is encoded into a vector (0, 1). It is assumed that the historical recommended object i₁ is mapped to a vector (0, 0, 0), and a user reward for the historical recommended object i₁ is encoded into a vector (0, 1). In this case, the spliced vector v₁ is (0, 0, 0, 0, 1), and the vector is the first vector that is input into the status generation model. The status generation model outputs the operation result j₁, and the operation result j₁ is represented in a form of a vector. It is assumed that the operation result j₁ is (4.3, 2.9, 0.4). The operation result j₁, a vector to which the historical recommended object i₂ is mapped, and a vector obtained by encoding a reward value of the user for the historical recommended object i₂ are used together as an input for a next operation of the status generation model, and the status generation model outputs the calculation result j₂. Likewise, the recommendation apparatus obtains the (t−1)^{th} operation result jₜ₋₁ output by the status generation model, and it is assumed that the operation result jₜ₋₁ is (3.4, 8.9, 6.7). The recommendation apparatus inputs the vector (3.4, 8.9, 6.7) into the selection policy to obtain a target to-be-recommended object.

Further, it is assumed that the historical status parameter of the user may include static information of the user, for example, a gender and an age, and may further include some statistical information, for example, a quantity of positive feedbacks (such as positive reviews or high scores) and a quantity of negative feedbacks (such as negative reviews or low scores) given by the user. The information may all be represented by a vector. For example, a gender “male” is represented by 0, a gender “female” is represented by 1, an age is represented by a specific value, and three consecutive positive reviews is represented by (3, 0) (where 0 indicates a quantity of negative reviews). In conclusion, a recommendation system status parameter corresponding to a 30-year-old female user who has given three consecutive positive reviews may be represented by a vector (1, 30, 3, 0, 3.4, 8.9, 6.7). The recommendation apparatus inputs the vector (1, 30, 3, 0, 3.4, 8.9, 6.7) into the selection policy to obtain the target to-be-recommended object.

In a possible embodiment, the status generation model may be implemented in a plurality of manners, for example, a neural network, a recurrent neural network, and weighting.

It should be noted that the recurrent neural network (recurrent neural networks, RNN) is used to process sequence data. In a conventional neural network model, a layer sequence is from an input layer to a hidden layer and then to an output layer, the layers are fully connected, and nodes in each layer are not connected. Such a common neural network resolves many problems, but is still incapable of resolving many other problems. For example, if a word in a sentence is to be predicted, a previous word usually needs to be used, because neighboring words in a sentence are not independent. A reason why the RNN is referred to as the recurrent neural network is that a current output of a sequence is also related to a previous output. A specific representation form is that the network memorizes previous information and applies the previous information to calculation of a current output, that is, nodes in the hidden layer are connected instead of not connected, and an input of the hidden layer not only includes an output of the input layer, but also includes an output of the hidden layer at a previous moment. Theoretically, the RNN can process sequence data of any length. An error backpropagation algorithm is used for training the RNN, but there is a difference: If the RNN is expanded, a parameter such as a weight W of the RNN is shared, which is different from the conventional neural network described above by using an example. In addition, during use of a gradient descent algorithm, an output of each step depends not only on a network of the current step, but also on a network status of one or more previous steps. The learning algorithm is referred to as a backpropagation through time (back propagation through time, BPTT) algorithm.

The RNN aims to enable a machine to have a memorizing capability like a human. Therefore, an output of the RNN needs to depend on current input information and historical memory information.

Further, the recurrent neural network includes a simple recurrent unit (simple recurrent unit, SRU) network. The SRU network has advantages such as being simple, fast, and more explanatory.

It should be noted that the recurrent neural network may alternatively be implemented in another specific form.

The following specifically describes implementing the status generation model in a weighting manner. After splicing the t−1 historical recommended object vectors and the corresponding reward vectors of the t−1 historical recommended object vectors to obtain the t−1 spliced vectors (that is, the spliced vectors v₁, v₂, . . . , and vₜ₋₁), the recommendation apparatus obtains a weighting result V according to a formula V=α₁xv₁+α₂xv₂+ . . . +αₜ₋₁xvₜ₋₁, where a₁, a₂, . . . , and aₜ₋₁ are weights. The weighting result V is also a vector, and the weighting result V is the recommendation system status parameter sₜ, or a result obtained by splicing the weighting result V and a vector to which the historical status parameter of the user is mapped is the recommendation system status parameter sₜ.

S202: The recommendation apparatus determines a target set from lower-level sets based on the recommendation system status parameter and according to a selection policy corresponding to an upper-level set.

The upper-level set and the lower-level sets are obtained by performing hierarchical clustering on a plurality of to-be-recommended objects, and the hierarchical clustering is grouping the to-be-recommended objects into a plurality of levels of sets. The upper-level set includes a plurality of lower-level sets.

It should be noted herein that it is assumed that the upper-level set may be a set of all the to-be-recommended objects, or may be a set of a type of to-be-recommended objects, depending on a specific different scenario. For example, in an application store, the upper-level set may be a set of all apps, for example, apps such as WeChat, QQ, Xiami music, Youku video, and iQIYI video, or the upper-level set may be a set of a type of apps, for example, a social application or an audio and video application.

Specifically, the recommendation apparatus inputs the recommendation system status parameter into the selection policy of the upper-level set, to obtain a probability distribution of the plurality of lower-level sets of the upper-level set, and the recommendation apparatus randomly selects one of the plurality of lower-level sets as the target set based on the probability distribution of the plurality of lower-level sets.

For example, it is assumed that the upper-level set is a level-1 set, and the lower-level set is a level-2 set. The level-1 set includes three level-2 sets: a level-2 set 1, a level-2 set 2, and a level-2 set 3. A probability distribution of the three level-2 sets may be represented as (level-2 set 1: b1, level-2 set 2: b2, level-2 set 3: b3), and indicates that a probability of the level-2 set 1 is b1, a probability of the level-2 set 2 is b2, and a probability of the level-2 set 3 is b3, where b1+b2+b3=1.

S203: The recommendation apparatus determines a target to-be-recommended object from the target set.

It should be noted herein that, before the recommendation apparatus determines the target to-be-recommended object from the lower-level set, a subset of the lower-level set, or a smaller set, the recommendation apparatus has grouped the plurality of to-be-recommended objects into sets based on a quantity of set levels, to obtain the plurality of sets, including a level-2 set, a level-3 set, or a smaller set. In addition, the quantity of set levels may be manually set, or may be a default value.

In a possible embodiment, each lower-level set corresponds to one selection policy, and the determining a target to-be-recommended object from the target set includes:

selecting the target to-be-recommended object from the target set according to a selection policy corresponding to the target set and based on the recommendation system status parameter.

Specifically, the recommendation apparatus inputs the recommendation system status parameter into the selection policy corresponding to the target set, to obtain a probability distribution of a plurality of to-be-recommended objects included in the target set, and then the recommendation apparatus randomly selects one of the plurality of to-be-recommended objects as the target to-be-recommended object based on the probability distribution of the plurality of to-be-recommended objects included in the target set.

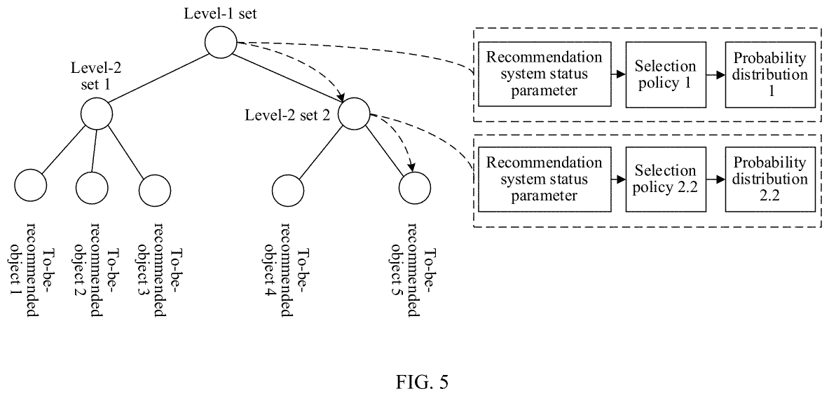

For example, as shown in FIG. 5, it is assumed that the plurality of to-be-recommended objects are grouped into two levels of sets: a level-1 set and level-2 sets.

The level-1 set includes two level-2 sets: a level-2 set 1 and a level-2 set 2. The level-2 set 1 includes three to-be-recommended objects: a to-be-recommended object 1, a to-be-recommended object 2, and a to-be-recommended object 3. The level-2 set 2 includes two to-be-recommended objects: a to-be-recommended object 4 and a to-be-recommended object 5. The level-1 set, the level-2 set 1, and the level-2 set 2 each correspond to one selection policy. The recommendation apparatus inputs the recommendation system status parameter into a selection policy (that is, a selection policy 1) corresponding to the level-1 set, to obtain a probability distribution (that is, a probability distribution 1) of the level-2 set 1 and the level-2 set 2, and then the recommendation apparatus randomly selects one of the level-2 set 1 and the level-2 set 2 as a target level-2 set based on the probability distribution of the level-2 set 1 and the level-2 set 2.

Assuming that the target level-2 set is the level-2 set 2, the recommendation apparatus inputs the recommendation system status parameter into a selection policy (that is, a selection policy 2.2) corresponding to the level-2 set 2, to obtain a probability distribution (that is, a probability distribution 2.2) of the to-be-recommended object 4 and the to-be-recommended object 5, then randomly selects one of the to-be-recommended object 4 and the to-be-recommended object 5 based on the probability distribution of the to-be-recommended object 4 and the to-be-recommended object 5, and determines the selected to-be-recommended object as the target to-be-recommended object. It is assumed that the target to-be-recommended object is the to-be-recommended object 5.

In a possible embodiment, the target set in the lower-level sets corresponds to one selection policy, the target set in the lower-level sets includes a plurality of subsets, the subset is a lower-level set of the target set, and the determining a target to-be-recommended object from the target set includes:

selecting, based on the recommendation system status parameter and according to the selection policy corresponding to the target set, a target subset from the plurality of subsets included in the target set; and

determining the target to-be-recommended object from the target subset.

Specifically, the recommendation apparatus inputs the recommendation system status parameter into the selection policy corresponding to the target set, to obtain a probability distribution of the plurality of subsets included in the target set, and then the recommendation apparatus randomly selects one of the plurality of subsets as the target subset based on the probability distribution of the plurality of subsets included in the target set. Finally, the recommendation apparatus determines the target to-be-recommended object from the target subset.

In an embodiment, each subset corresponds to one selection policy, and each subset includes a plurality of to-be-recommended objects. That the recommendation apparatus determines a target to-be-recommended object from the target subset includes:

determining, by the recommendation apparatus, the target to-be-recommended object from the target subset based on the recommendation system status parameter and according to a selection policy corresponding to the target subset.

Specifically, the recommendation apparatus inputs the recommendation system status parameter into the selection policy corresponding to the target subset, to obtain a probability distribution of a plurality of to-be-recommended objects included in the target subset, and the recommendation apparatus randomly selects one of the plurality of to-be-recommended objects as the target to-be-recommended object based on the probability distribution of the plurality of to-be-recommended objects.

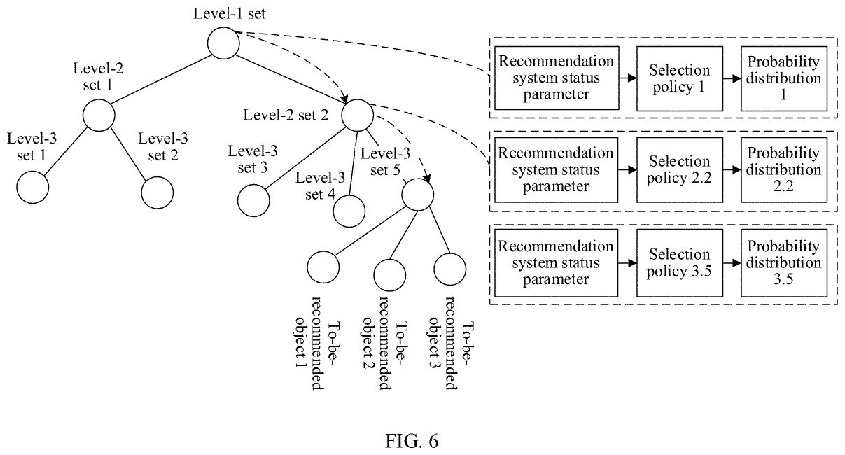

For example, as shown in FIG. 6, it is assumed that the plurality of to-be-recommended objects are grouped into three levels of sets: a level-1 set, level-2 sets, and level-3 sets.

The level-1 set includes two level-2 sets: a level-2 set 1 and a level-2 set 2. The level-2 set 1 includes two level-3 sets: a level-3 set 1 and a level-3 set 2. The level-2 set 2 includes three level-3 sets: a level-3 set 3, a level-3 set 4, and a level-3 set 5. The level-3 set 1, the level-3 set 2, the level-3 set 3, the level-3 set 4, and the level-3 set 5 each include a plurality of to-be-recommended objects. The level-1 set, the level-2 set 1, the level-2 set 2, the level-3 set 1, the level-3 set 2, the level-3 set 3, the level-3 set 4, and the level-3 set 5 each correspond to one selection policy. The recommendation apparatus inputs the recommendation system status parameter into a selection policy (that is, a selection policy 1) corresponding to the level-1 set, to obtain a probability distribution (that is, a probability distribution 1) of the level-2 set 1 and the level-2 set 2, and then the recommendation apparatus randomly selects one of the level-2 set 1 and the level-2 set 2 as a target level-2 set based on the probability distribution of the level-2 set 1 and the level-2 set 2. Assuming that the target level-2 set is the level-2 set 2, the recommendation apparatus inputs the recommendation system status parameter into a selection policy (that is, a selection policy 2.2) corresponding to the level-2 set 2, to obtain a probability distribution (that is, a probability distribution 2.2) of the level-3 set 3, the level-3 set 4, and the level-3 set 5, and then the recommendation apparatus randomly selects one of the level-3 set 3, the level-3 set 4, and the level-3 set 5 as a target level-3 set based on the probability distribution 3. Assuming that the target level-3 set is the level-3 set 5, the recommendation apparatus inputs the recommendation system status parameter into a selection policy (that is, a selection policy 3.5) corresponding to the level-3 set 5, to obtain a probability distribution (that is, a probability distribution 3.5) of the to-be-recommended object 1, the to-be-recommended object 2, and the to-be-recommended object 3, and then the recommendation apparatus randomly selects one of the to-be-recommended object 1, the to-be-recommended object 2, and the to-be-recommended object 3 as the target to-be-recommended object based on the probability distribution 3. As shown in FIG. 6, the target to-be-recommended object is the to-be-recommended object 3.

It should be noted that FIG. 6 shows only three to-be-recommended objects included in the level-3 set 5, and another level-3 set also includes a plurality of to-be-recommended objects, which are not shown.

It should be noted that hierarchical clustering means grouping the plurality of to-be-recommended objects into N levels of sets based on a preset quantity of levels, where N≥2. A level-1 set is a total set of all the to-be-recommended objects on which hierarchical clustering is to be performed, and the level-1 set usually includes a plurality of level-2 sets. In addition, a total quantity of to-be-recommended objects included in the plurality of level-2 sets is equal to a quantity of the to-be-recommended objects included in the level-1 set. A specific quantity of the level-2 sets may be preset or may be related to a hierarchical clustering manner. When N=2, only two levels of sets are obtained through hierarchical clustering, and the level-2 set does not include a lower-level set. Each level-i set includes a plurality of level-i+1 sets, where i ∈ {1, 2, . . . , N−1}. A level-N set directly includes to-be-recommended objects, and set grouping is no longer performed. FIG. 5 is a schematic diagram of performing hierarchical clustering to group a plurality of to-be-recommended objects into two levels of sets.

For example, it is assumed that for an application market, a level-1 set includes a plurality of level-2 sets, and the plurality of level-2 sets include a communication and social set, an information reading set, a business office set, and an audio/video/image set. Each of the plurality of level-2 sets includes a plurality of level-3 sets. The communication and social set includes a chat set, a community set, a friend making set, and a communication set. The information reading set includes a novel book set, a news set, a magazine set, and a cartoon set. The business office set includes an office set, a mailbox set, a note set, and a file management set. The audio/video/image set includes a video set, a music set, a camera set, and a short video set. Each of the plurality of level-3 sets includes a plurality of to-be-recommended objects, that is, applications. For example, the chat set includes QQ, WeChat, Tantan, and the like; the community set includes QQ space, Baidu Tieba, Zhihu, Douban, and the like; the news set includes Toutiao, Tencent News, Ifeng News, and the like; the novel book set includes Qidian Reading, Migu Reading, Shuqi Novels, and the like; the office set includes DingTalk, WPS Office, Adobe Reader, and the like; the mailbox set includes QQ Postbox, NetEase Mail Master, Gmail, and the like; the music set includes Xiami Music, Kugou Music, QQ Music, and the like; and the short video set includes Tik Tok, Kuaishou, Vigo Video, and the like.

In a possible embodiment, the performing hierarchical clustering on a plurality of to-be-recommended objects includes: performing hierarchical clustering on the plurality of to-be-recommended objects by constructing a balanced clustering tree.

It should be noted herein that, the recommendation apparatus obtains the upper-level set or the lower-level sets through grouping in a balanced clustering tree manner, so as to construct a balanced clustering tree by using the plurality of to-be-recommended objects based on a total quantity of the to-be-recommended objects and a preset tree depth. Each leaf node of the balanced clustering tree corresponds to one to-be-recommended object, and each non-leaf node corresponds to one set, where the set may be a level-1 set, a level-2 set, a level-3 set, or a smaller set. For each node of the balanced clustering tree, a maximum difference between depths of subtrees of the node is 1. Each non-leaf node of the balanced clustering tree has c subnodes. A tree in which a subnode of each non-leaf node is a root node is a balanced tree.

Non-leaf nodes other than a parent node of a leaf node each have c subnodes (that is, an upper-level set includes c lower-level sets), and a tree whose non-leaf node is a root node is also a balanced tree, where c is an integer greater than or equal to 2.

A depth of the balanced clustering tree may be preset, or may be manually set.

Optionally, a manner of the hierarchical clustering may be a manner based on a k-means-based clustering algorithm, a PCA-based clustering algorithm, or another clustering algorithm.

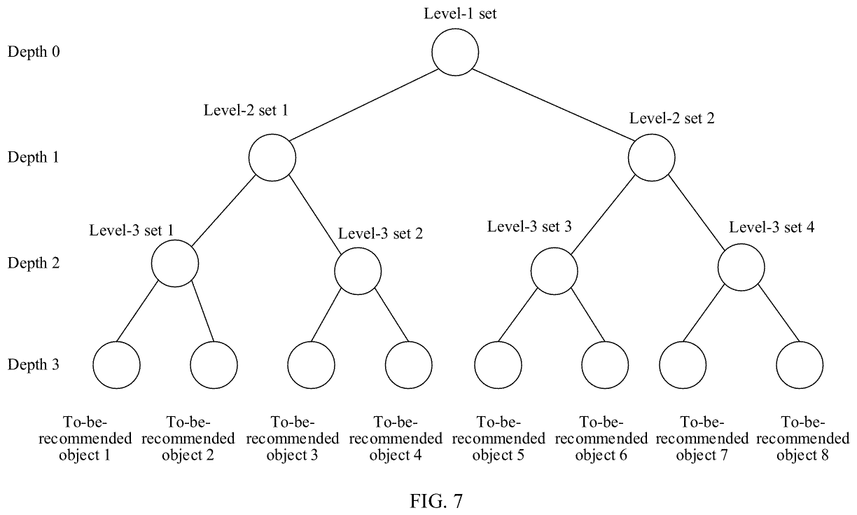

For example, it is assumed that there are eight to-be-recommended objects: a to-be-recommended object 1, a to-be-recommended object 2, . . . , and a to-be-recommended object 8. The recommendation apparatus performs hierarchical clustering on the eight to-be-recommended objects in the balanced clustering tree manner based on a tree depth and a quantity of the to-be-recommended objects, to obtain a balanced clustering tree shown in FIG. 7. The balanced clustering tree shown in FIG. 7 is a binary tree, and a root node (that is, a level-1 set) of the balanced clustering tree includes two level-2 sets: a level-2 set 1 and a level-2 set 2. The level-2 set 1 includes two level-3 sets: a level-3 set 1 and a level-3 set 2. The level-2 set 3 also includes two level-3 sets: a level-3 set 3 and a level-3 set 4. The level-3 set 1, the level-3 set 2, the level-3 set 3, and the level-3 set 4 each include two to-be-recommended objects.

In other words, the recommendation apparatus classifies the eight to-be-recommended objects (that is, the level-1 set) into two types (the level-2 set 1 and the level-2 set 2), to-be-recommended objects in the level-2 set 1 are further classified into two types (the level-3 set 1 and the level-3 set 2), and to-be-recommended objects in the level-2 set 2 are also classified into two types (the level-3 set 3 and the level-3 set 4). The level-3 set 1 includes the to-be-recommended object 1 and the to-be-recommended object 2. The level-3 set 2 includes the to-be-recommended object 3 and the to-be-recommended object 4. The level-3 set 3 includes the to-be-recommended object 5 and the to-be-recommended object 6. The level-3 set 4 includes the to-be-recommended object 7 and the to-be-recommended object 8.

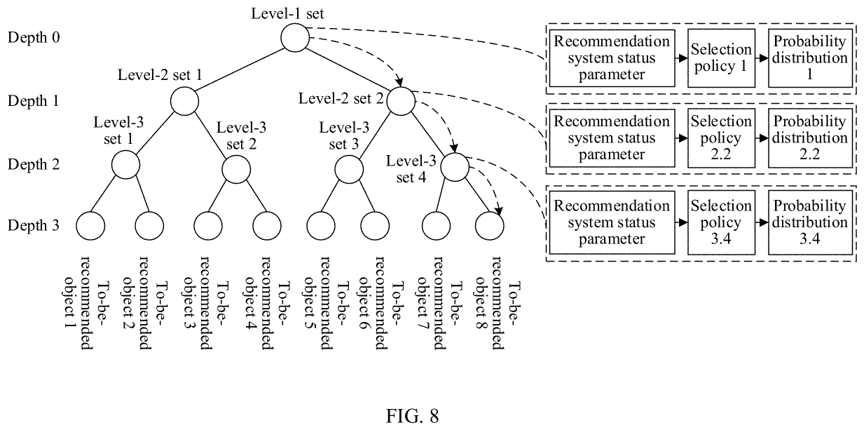

After the eight to-be-recommended objects are constructed according to the foregoing method into the balanced clustering tree shown in FIG. 7, as shown in FIG. 8, the recommendation apparatus inputs the recommendation system status parameter into a selection policy (that is, a selection policy 1) corresponding to the level-1 set, to obtain a probability distribution (that is, a probability distribution 1) of the level-2 sets (that is, the level-2 set 1 and the level-2 set 2) included in the level-1 set. The recommendation apparatus randomly selects one of the level-2 set 1 and the level-2 set 2 as a target level-2 set based on the probability distribution of the level-2 set 1 and the level-2 set 2. Assuming that the target level-2 set is the level-2 set 2, the recommendation apparatus inputs the recommendation system status parameter into a selection policy (that is, a selection policy 2.2) corresponding to the level-2 set 2, to obtain a probability distribution (that is, a probability distribution 2.2) of the level-3 sets (that is, the level-3 set 3 and the level-3 set 4) included in the level-2 set 2. The recommendation apparatus randomly selects one of the level-3 set 3 and the level-3 set 4 as a target level-3 set based on the probability distribution of the level-3 set 3 and the level-3 set 4. Assuming that the target level-3 set is the level-3 set 4, the recommendation apparatus inputs the recommendation system status parameter into a selection policy (that is, a selection policy 3.4) corresponding to the level-3 set 4, to obtain a probability distribution (that is, a probability distribution 3.4) of the to-be-recommended object 7 and the to-be-recommended object 8. The recommendation apparatus randomly selects one of the to-be-recommended object 7 and the to-be-recommended object 8 as the target to-be-recommended object based on the probability distribution of the to-be-recommended object 7 and the to-be-recommended object 8.

For another example, each set in the balanced clustering tree corresponds to one selection policy. An input of the selection policy is the recommendation system status parameter, and an output of the selection policy is a subset of a set or a probability distribution of to-be-recommended objects. As shown in FIG. 7, the recommendation apparatus inputs the recommendation system status parameter sₜ into the selection policy 1 corresponding to the level-1 set, to obtain the probability distribution of the level-2 set 1 and the level-2 set 2: the level-2 set 1: 0.4, the level-2 set 2: 0.6. The recommendation apparatus randomly determines, from the level-2 set 1 and the level-2 set 2, the level-2 set 2 as the target level-2 set based on the probability distribution (that is, the level-2 set 1: 0.4, the level-2 set 2: 0.6). The recommendation apparatus inputs the recommendation system status parameter sₜ into the selection policy corresponding to the level-2 set 2, to obtain the probability distribution of the level-3 set 3 and the level-3 set 4. For example, the probability distribution is (the level-3 set 3: 0.1, the level-3 set 4: 0.9). The recommendation apparatus randomly determines, from the level-3 set 3 and the level-3 set 4, the level-3 set 4 as the target level-3 set based on the probability distribution. The level-3 set 4 includes the to-be-recommended object 7 and the to-be-recommended object 8. The recommendation apparatus inputs the recommendation system status parameter sₜ into the selection policy corresponding to the level-3 set 4, to obtain the probability distribution of the to-be-recommended object 7 and the to-be-recommended object 8. For example, the probability distribution is (the to-be-recommended object 7: 0.2, the to-be-recommended object 8: 0.8). The recommendation apparatus randomly determines, from the to-be-recommended object 7 and the to-be-recommended object 8, the to-be-recommended object 8 as the target to-be-recommended object based on the probability distribution. In other words, the to-be-recommended object 8 is recommended to the user this time.

In a possible embodiment, in the balanced clustering tree, a quantity of to-be-recommended objects included by a parent node of the to-be-recommended object may be less than c.

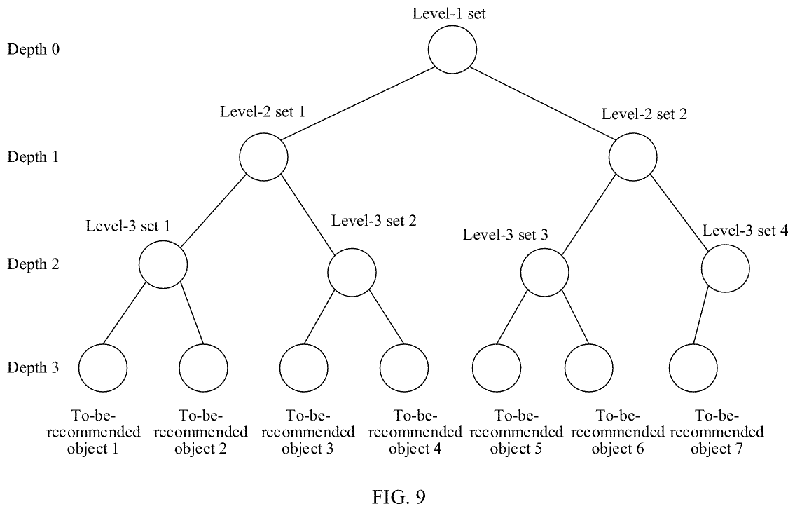

As shown in FIG. 9, a level-1 set includes two level-2 sets: a level-2 set 1 and a level-2 set 2; the level-2 set 1 includes two level-3 sets: a level-3 set 1 and a level-3 set 2; and the level-2 set 3 also includes two level-3 sets: a level-3 set 3 and a level-3 set 4. The level-3 set 1, the level-3 set 2, and the level-3 set 3 each include two to-be-recommended objects, and the level-3 set 4 includes only one to-be-recommended object.

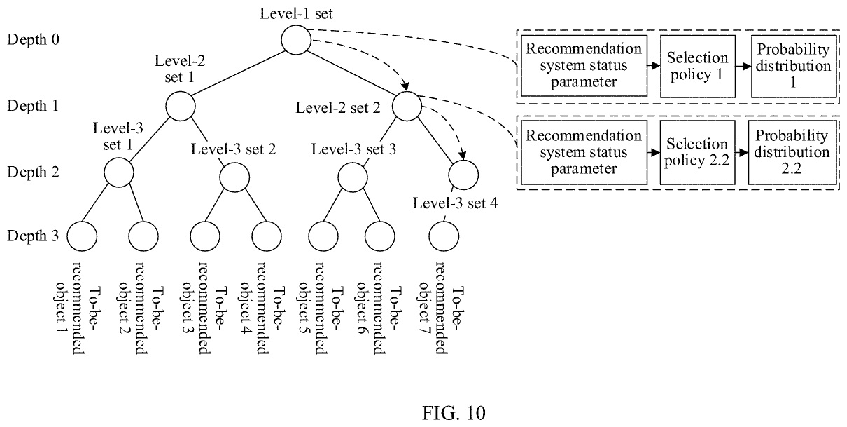

After the eight to-be-recommended objects are constructed according to the foregoing method into the balanced clustering tree shown in FIG. 9, as shown in FIG. 10, the recommendation apparatus inputs the recommendation system status parameter into a selection policy (that is, a selection policy 1) corresponding to the level-1 set, to obtain a probability distribution (that is, a probability distribution 1) of the level-2 sets (that is, the level-2 set 1 and the level-2 set 2) included in the level-1 set. The recommendation apparatus randomly selects one of the level-2 set 1 and the level-2 set 2 as a target level-2 set based on the probability distribution of the level-2 set 1 and the level-2 set 2. Assuming that the target level-2 set is the level-2 set 2, the recommendation apparatus inputs the recommendation system status parameter into a selection policy (that is, a selection policy 2.2) corresponding to the level-2 set 2, to obtain a probability distribution (that is, a probability distribution 2.2) of the level-3 sets (that is, the level-3 set 3 and the level-3 set 4) included in the level-2 set 2. The recommendation apparatus randomly selects one of the level-3 set 3 and the level-3 set 4 as a target level-3 set based on the probability distribution 2.2. Assuming that the target level-3 set is the level-3 set 4, because the level-3 set 4 includes only one to-be-recommended object (that is, the to-be-recommended object 7), the recommendation apparatus directly determines the to-be-recommended object 7 as the target to-be-recommended object.

In a possible embodiment, after determining the target to-be-recommended object based on the recommendation status system parameter, the recommendation apparatus recommends the target to-be-recommended object to the user, then receives a user behavior for the target to-be-recommended object, and determines a reward of the target to-be-recommended object based on the user behavior. Finally, the recommendation apparatus uses the recommendation system status parameter, the target to-be-recommended object, and the reward of the target to-be-recommended object as an input of next recommendation.

In a possible embodiment, the selection policy and the status generation model are obtained through machine learning and training, and training sample data is (s₁, a₁, r₁, s₂, a₂, r₂, . . . , sₙ, aₙ, rₙ), where (a₁, a₂, . . . , aₙ) are historical recommendation actions or historical recommended objects; r₁, r₂, . . . , and rₙ are reward values obtained through calculation based on user behaviors for the historical recommended objects (a₁, a₂, . . . , aₙ), respectively; and (s₁, s₂, . . . , sₙ) are historical recommendation system status parameters.

Specifically, before recommending the object based on the selection policy and the status generation model, the recommendation apparatus needs to train the selection policy and the status generation model based on a machine learning algorithm. A specific process is as follows: The recommendation apparatus first randomly initializes all parameters, where the parameters include a parameter in the status generation model and a parameter in a selection policy corresponding to a non-leaf node (that is, a set) in the balanced clustering tree. Then, the recommendation apparatus samples recommendation information of one episode (episode), that is, one piece of training sample data (s₁, a₁, r₁, s₂, a₂, r₂, sₙ, aₙ, rₙ).

It should be noted that the recommendation apparatus initializes the first state s₁ to 0. The recommendation action is recommending an object to the user. Therefore, the recommendation action may be considered as a recommended object. The reward is a user reward for the recommendation action or the recommended object.

It should be noted that the training sample data (s₁, a₁, r₁, s₂, a₂, r₂, sₙ, aₙ, rₙ) includes n recommendation samples, and the i^{th} recommendation sample may be represented as (sᵢ, aᵢ, rᵢ). The n recommendation samples may be obtained by recommending an object to different users, or may be obtained by recommending objects to a same user.

The recommendation apparatus calculates a Q value of each of n recommendation actions in the episode according to a first formula, where the first formula may be expressed as:

Q^{π}^{_{θ}}(sₜ, aₜ)=Σᵢ₌ₜⁿγ^{i-t}rᵢ

Q^{π}^{_{θ}}(sₜ, aₜ) represents a Q value of the t^{th} recommendation action, θ represents all parameters in the status generation model and the selection policy, sₜ represents the t^{th} recommendation system status parameter in the n recommendation system status parameters, aₜ represents the t^{th} recommendation action in the n recommendation actions, γ represents a discount rate, and rᵢ represents a user reward for the i^{th} recommendation action or the i^{th} recommended object.

Then, the recommendation apparatus obtains, based on the Q value of each of the n recommendation actions, a policy gradient corresponding to the recommendation action. A policy gradient corresponding to the t^{th} recommendation action in the n recommendation actions may be represented as ∇_{θ} log π_{θ}(aₜ|sₜ)Q^{π}^{_{θ}}(sₜaₜ), where π_{θ}(aₜ|sₜ) represents a probability of obtaining a recommendation action aₜ based on the recommendation system status parameter sₜ.

The recommendation apparatus obtains a parameter update amount Δθ based on the policy gradient corresponding to each of the n recommendation actions. Specifically, the recommendation apparatus performs iterative summation on the policy gradients corresponding to all of the n recommendation actions, to obtain the parameter update amount Δθ. The parameter update amount Δθ may be expressed as Δθ=Δθ+∇_{θ} log π_{θ}(aₜ|sₜ)Q^{π}^{_{θ}}(sₜ, aₜ).

After obtaining the parameter update amount Δθ, the recommendation apparatus updates all the parameters θ according to a second formula, where the second formula is θ=θ+ηΔθ.

The recommendation apparatus repeats the foregoing process (including steps from episode sampling to parameter θ updating) until both the selection policy and the status generation model are converged. In this way, training of models (including the selection policy and the status generation model) is completed.

It should be noted that convergence of the selection policy and the status generation model means that a loss (loss) of the selection policy and the status generation model is stable and no longer decreases.

In a possible embodiment, the loss (loss) may be defined as a distance between a reward predicted by the models (including the selection policy and the status generation model) and a real reward.

In a possible embodiment, after the recommendation apparatus completes recommendation of one episode according to related descriptions of steps S201 to S203, the recommendation apparatus retrains the status generation model and the selection policy based on recommendation information of the episode according to the foregoing method.

In a possible embodiment, the selection policy and the status generation model are trained on a third-party server. After the third-party server trains the selection policy and the status generation model, the recommendation apparatus directly obtains the trained selection policy and the trained status generation model from the third-party server.

In a possible example, after obtaining the selection policy and the status generation model, the recommendation apparatus determines the target to-be-recommended object based on the selection policy and the status generation model, and then sends the target to-be-recommended object to a terminal device of the user.

In a possible embodiment, after the determining a target to-be-recommended object, the method further includes: obtaining the user behavior for the target to-be-recommended object; and using the target to-be-recommended object and the user behavior for the target to-be-recommended object as historical data to determine a next to-be-recommended object.

It can be learned that, in the solution in this embodiment of the present invention, the recommendation system status parameter is obtained based on the plurality of historical recommended objects and the user behavior for each historical recommended object; the target set in the lower-level sets is determined from the lower-level sets based on the recommendation system status parameter and according to the selection policy corresponding to the upper-level set, where the upper-level set and the lower-level sets are obtained by performing hierarchical clustering on the plurality of to-be-recommended objects, the hierarchical clustering is grouping the to-be-recommended objects into the plurality of levels of sets, and the upper-level set includes n lower-level sets; and the target to-be-recommended object is determined from the target set. This embodiment of the present invention helps improve efficiency and accuracy of object recommendation.

In a specific application scenario, the recommendation apparatus recommends a movie to the user. The recommendation apparatus first obtains a status generation model and a selection policy. The recommendation apparatus obtains, from a third-party server, the status generation model and the selection policy that are trained by the third-party server, or the recommendation apparatus locally trains and obtains the status generation model and the selection policy.

That the recommendation apparatus locally trains the status generation model and the selection policy specifically includes: The recommendation apparatus obtains, through sampling, recommendation information of one recommendation episode, that is, one piece of training sample data. The training sample data includes n recommendation samples. The i^{th} recommendation sample may be represented as (sᵢ, mᵢ, rᵢ), where sᵢ represents a recommendation system status parameter used for the i^{th} recommendation in the recommendation episode, mᵢ represents a movie recommended to the user during the i^{th} recommendation in the recommendation episode, and rᵢ represents a reward value for the i^{th} movie recommendation.

A reward value of the recommended movie may be determined based on a user behavior for the recommended movie. For example, if the user watches the recommended movie, the reward value is 1; or if the user does not watch the recommended movie, the reward value is 0. For another example, if the user watches the recommended movie for 30 minutes, the reward value is 30. For another example, if the user watches the recommended movie for four times consecutively, the reward value is 4.

The recommendation apparatus or the third-party server may train and obtain the status generation model and the selection policy according to related descriptions in the embodiment shown in FIG. 2.

After obtaining the status generation model and the selection policy, the recommendation apparatus obtains t historical recommended movies and a user behavior for each historical recommended movie. The recommendation apparatus determines a reward value of each historical recommended movie based on the user behavior for the historical recommended movie. Then, the recommendation apparatus processes the t historical recommended movies and the reward value of each historical recommended movie by using the status generation model, to obtain a recommendation system status parameter.

Before recommending the movie based on the recommendation system recommendation parameter, the recommendation apparatus divides, into a plurality of level-2 sets, a level-1 set that includes a plurality of to-be-recommended movies. Each level-2 set includes a plurality of to-be-recommended movies. Alternatively, further, the recommendation apparatus divides each level-2 set into a plurality of level-3 sets, and each level-3 set includes a plurality of to-be-recommended movies.

Further, the plurality of to-be-recommended movies may be further grouped into smaller sets.

For example, the recommendation apparatus may obtain sets through grouping based on origins and categories of the movies. A level-1 set includes a plurality of level-2 sets, and the plurality of level-2 sets include a mainland movie set, a Hong Kong and Taiwan movie set, and an American movie set. Each level-2 set includes a plurality of level-3 sets. The mainland movie set includes a war movie set, a police and bandit movie set, and a horror movie set. The Hong Kong and Taiwan movie set includes a drama movie set, a martial arts film set, and a comedy movie set. The American movie set includes a love movie set, a thriller movie set, and a fantasy movie set. Each level-3 set includes a plurality of to-be-recommended movies. For example, the war movie set includes WM01, WM02, and WM03, the police and bandit movie set includes PBM01 and PBM02, the martial arts film set includes MAF01, MAF02, and MAF03, the thriller movie set includes The Grudge (The Grudge), Resident Evil (Resident Evil), and Anaconda (Anaconda), and the fantasy movie set includes Mummy (Mummy), Tomb Raider (Tomb Raider), and Pirates of the Caribbean (Pirates of the Caribbean).

In some possible embodiments, the recommendation apparatus may alternatively obtain sets through grouping based on leading actors/actresses, directors, or release time of the movies.

If the level-1 set includes a plurality of level-2 sets, each level-2 set includes one or more to-be-recommended objects, and the level-1 set and the level-2 set each correspond to one selection policy, the recommendation apparatus inputs the recommendation system status into a selection policy corresponding to the level-1 set, to obtain a probability distribution of the plurality of level-2 sets included in the level-1 set; and randomly selects one of the plurality of level-2 sets based on the probability distribution of the plurality of level-2 sets, and determines the selected level-2 set as a target level-2 set. Then, the recommendation apparatus inputs the recommendation system status parameter into a selection policy corresponding to the target level-2 set, to obtain a probability distribution of a plurality of to-be-recommended movies included in the target level-2 set; and then randomly selects one of the plurality of to-be-recommended movies based on the probability distribution of the plurality of to-be-recommended movies, and determines the selected to-be-recommended movie as a target to-be-recommended movie. If the target level-2 set includes only one to-be-recommended movie, the recommendation apparatus directly determines the to-be-recommended movie included in the target level-2 set as the target to-be-recommended movie.

If the level-1 set includes a plurality of level-2 sets, each level-2 set includes a plurality of level-3 sets, each level-3 set includes one or more to-be-recommended movies, and the level-1 set, each level-2 set, and each level-3 set each correspond to one selection policy, the recommendation apparatus inputs the recommendation system status into a selection policy corresponding to the level-1 set, to obtain a probability distribution of the plurality of level-2 sets included in the level-1 set; and randomly selects one of the plurality of level-2 sets based on the probability distribution of the plurality of level-2 sets, and determines the selected level-2 set as a target level-2 set. Then, the recommendation apparatus inputs the recommendation system status parameter into a selection policy corresponding to the target level-2 set, to obtain a probability distribution of the plurality of level 3; sets included in the target level-2 set; and randomly selects one of the plurality of level-3 sets based on the probability distribution of the plurality of level-3 sets, and determines the selected level-3 set as a target level-3 set. If the target level-3 set includes a plurality of to-be-recommended movies, the recommendation apparatus inputs the recommendation system status parameter into a selection policy corresponding to the target level-3 set, to obtain a probability distribution of the plurality of to-be-recommended movies included in the target level-3 set; and randomly selects one of the plurality of to-be-recommended movies based on the probability distribution of the plurality of to-be-recommended movies, and determines the selected to-be-recommended movie as the target to-be-recommended movie. If the target level-3 set includes only one to-be-recommended movie, the recommendation apparatus determines the to-be-recommended movie included in the target level-3 set as the target to-be-recommended movie.

After recommending the target to-be-recommended movie to the user, the recommendation apparatus obtains a user behavior for the target to-be-recommended movie. The user behavior may be clicking to watch the target to-be-recommended movie, may be duration of watching the target to-be-recommended movie, or may be a quantity of consecutive times the user watches the target to-be-recommended movie. The recommendation apparatus obtains a reward value of the target to-be-recommended movie based on the user behavior, and then uses the target to-be-recommended movie and the reward value of the target to-be-recommended movie as historical data to determine a next target to-be-recommended movie.

In another specific application scenario, the recommendation apparatus recommends information to the user. The recommendation apparatus first obtains a status generation model and a selection policy. The recommendation apparatus obtains, from a third-party server, the status generation model and the selection policy that are trained by the third-party server, or the recommendation apparatus locally trains and obtains the status generation model and the selection policy.

That the recommendation apparatus locally trains the status generation model and the selection policy specifically includes: The recommendation apparatus obtains, through sampling, recommendation information of one recommendation episode, that is, one piece of training sample data. The training sample data includes n recommendation samples. The i^{th} recommendation sample may be represented as (sᵢ, mᵢ, rᵢ), where sᵢ represents a recommendation system status parameter used for the i^{th} recommendation in the recommendation episode, mᵢ represents information recommended to the user during the i^{th} recommendation in the recommendation episode, and rᵢ represents a reward value for the i^{th} information recommendation.

A reward value of the recommended movie may be determined based on a user behavior for the recommended information. For example, if the user clicks to view the recommended information, the reward value is 1; or if the user does not click the recommended information, the reward value is 0. or example, the user views the recommended information, but closes the information page after viewing a part of the information, because the user finds that the information is not interesting. In this case, a percentage of the viewed part in the recommended information is 35%, and the reward value of the recommended information is 3.5. If the recommended information is a news video and the user watches the recommended news video for five minutes, the reward value is 5.

The recommendation apparatus or the third-party server may train and obtain the status generation model and the selection policy according to related descriptions in the embodiment shown in FIG. 2.

After obtaining the status generation model and the selection policy, the recommendation apparatus obtains t pieces of historical recommended information and a user behavior for each piece of historical recommended information. The recommendation apparatus determines a reward value of each piece of historical recommended information based on the user behavior for the historical recommended information. Then, the recommendation apparatus processes the t pieces of historical recommended information and the reward value of each piece of historical recommended information by using the status generation model, to obtain a recommendation system status parameter.

Before recommending the information based on the recommendation system recommendation parameter, the recommendation apparatus divides, into a plurality of level-2 sets, a level-1 set that includes a plurality of pieces of to-be-recommended information. Each level-2 set includes one or more pieces of to-be-recommended information. Alternatively, further, the recommendation apparatus divides each level-2 set into a plurality of level-3 sets, and each level-3 set includes one or more pieces of to-be-recommended information.

Further, the plurality of pieces of to-be-recommended information may be further grouped into smaller sets.

For example, the recommendation apparatus may obtain sets through grouping based on types of the information. A level-1 set includes a plurality of level-2 sets, and the plurality of level-2 sets include a video information set, a text information set, and an image-and-text information set. Each level-2 set includes a plurality of level-3 sets. For example, the video information set includes an international information set, an entertainment information set, and a movie information set. The international information set, the entertainment information set, and the movie information set each include one or more pieces of information. The image-and-text information set includes a technology information set, a sports information set, and a financial information set. The technology information set, the sports information set, and the financial information set each include one or more pieces of information. The text information set includes an education information set, a three-rural-issues information set, and a tourism information set. The education information set, the three-rural-issues information set, and the tourism information set each include one or more pieces of information.

If the level-1 set includes a plurality of level-2 sets, each level-2 set includes a plurality of level-3 sets, each level-3 set includes one or more to-be-recommended movies, and the level-1 set, each level-2 set, and each level-3 set each correspond to one selection policy, the recommendation apparatus inputs the recommendation system status into a selection policy corresponding to the level-1 set, to obtain a probability distribution of the plurality of level-2 sets (that is, the video information set, the text information set, and the image-and-text information set) included in the level-1 set; and randomly selects one of the plurality of level-2 sets based on the probability distribution of the plurality of level-2 sets, and determines the selected level-2 set as a target level-2 set. It is assumed that the target level-2 set is the image-and-text information set. Then, the recommendation apparatus inputs the recommendation system status parameter into a selection policy corresponding to the image-and-text information set, to obtain a probability distribution of the sets (that is, the technology information set, the sports information set, and the financial information set) included in the image-and-text information set; and then randomly selects one of probabilities of the technology information set, the sports information set, and the financial information set based on the probability distribution, and determines the selected set as a target level-3 set. It is assumed that the target level-3 set is the technology information set. If the technology information set includes a plurality of pieces of to-be-recommended information, the recommendation apparatus inputs the recommendation system status parameter into a selection policy corresponding to the technology information set, to obtain a probability distribution of the plurality of pieces of to-be-recommended information included in the technology information set; and randomly selects one of the plurality of pieces of to-be-recommended information based on the probability distribution of the plurality of pieces of to-be-recommended information, and determines the selected to-be-recommended information as target to-be-recommended information. If the target level-3 set includes only one piece of to-be-recommended information, the recommendation apparatus determines the to-be-recommended information as the target to-be-recommended information.

After recommending the target to-be-recommended information to the user, the recommendation apparatus obtains a user behavior for the target to-be-recommended information. The user behavior may be clicking to view the target to-be-recommended information, or may be a percentage of a viewed part of the target to-be-recommended information. The recommendation apparatus obtains a reward value of the target to-be-recommended information based on the user behavior, and then uses the target to-be-recommended information and the reward value of the target to-be-recommended information as historical data to determine next target to-be-recommended information.

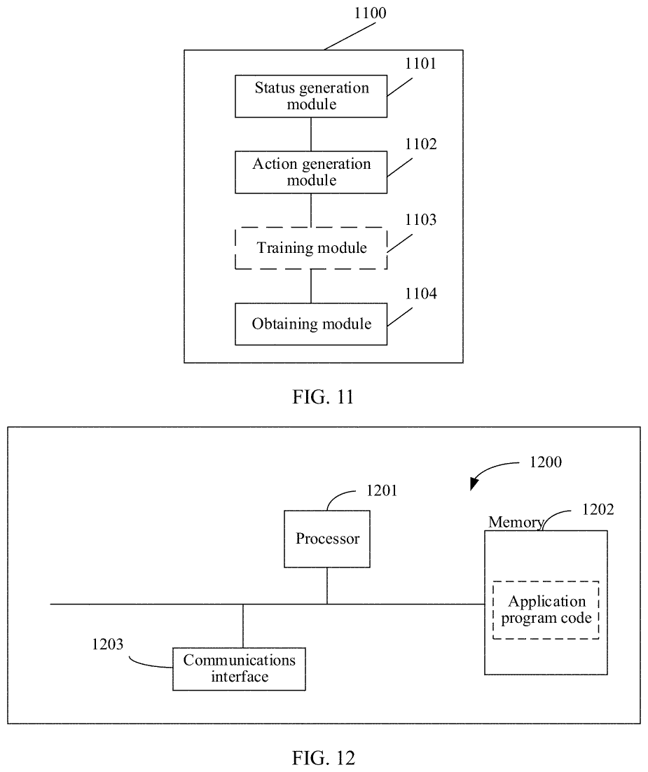

FIG. 11 is a schematic structural diagram of a recommendation apparatus according to an embodiment of the present invention. As shown in FIG. 11, the recommendation apparatus 1100 includes:

a status generation module 1101, configured to obtain a recommendation system status parameter based on a plurality of historical recommended objects and a user behavior for each historical recommended object.

In a possible embodiment, the status generation module 1101 is specifically configured to:

determine a reward value of each historical recommended object based on the user behavior for the historical recommended object; and

input the plurality of historical recommended objects and reward values of the plurality of historical recommended objects into a status generation model, to obtain the recommendation system status parameter, where the status generation model is a recurrent neural network model.

The recommendation apparatus 1100 further includes an action generation module 1102, configured to: determine a target set in lower-level sets from the lower-level sets based on the recommendation system status parameter and according to a selection policy corresponding to an upper-level set; and determine a target to-be-recommended object from the target set.

The upper-level set and the lower-level sets are obtained by performing hierarchical clustering on a plurality of to-be-recommended objects, the hierarchical clustering is grouping the to-be-recommended objects into a plurality of levels of sets, and the upper-level set includes a plurality of lower-level sets.

In a possible embodiment, the target set in the lower-level sets corresponds to one selection policy, the target set in the lower-level sets includes a plurality of subsets, the subset is a lower-level set of the target set, and in terms of the determining a target to-be-recommended object from the target set, the action generation module 1102 is specifically configured to:

select, based on the recommendation system status parameter and according to the selection policy corresponding to the target set, a target subset from the plurality of subsets included in the target set; and determine the target to-be-recommended object from the target subset.

In a possible embodiment, each lower-level set corresponds to one selection policy, and in terms of the determining a target to-be-recommended object from the target set, the action generation module 1102 is specifically configured to:

select the target to-be-recommended object from the target set according to a selection policy corresponding to the target set and based on the recommendation system status parameter.

In a possible embodiment, the performing hierarchical clustering on a plurality of to-be-recommended objects includes: performing hierarchical clustering on the plurality of to-be-recommended objects by constructing a balanced clustering tree.

In a possible embodiment, the selection policy is a fully connected neural network model.

In a possible embodiment, the recommendation apparatus 1100 further includes:

a training module 1103, configured to obtain the selection policy and the status generation model through machine learning and training, where training sample data is (s₁, a₁, r₁, s₂, a₂, r₂, . . . , sₜ, aₜ, rₜ), a₂, . . . , aₜ) are historical recommended objects; r₁, r₂, . . . , and rₜ are reward values obtained through calculation based on user behaviors for the historical recommended objects (a₁, a₂, . . . , aₜ), respectively; and (s₁, s₂, . . . , sₜ) are historical recommendation system status parameters.

It should be noted that the training module 1103 is optional, because a process of obtaining the selection policy and the status generation model through machine learning and training may alternatively be performed by a third-party server. Before determining the target to-be-recommended object, the recommendation apparatus 1100 sends a request message to the third-party server. The request message is used to request to obtain the selection policy and the status generation model. The third-party server sends a response message to the recommendation apparatus 1100. The response message carries the selection policy and the status generation model.

In a possible embodiment, the recommendation apparatus 1100 further includes:

an obtaining module 1104, configured to obtain a user behavior for the target to-be-recommended object after the target to-be-recommended object is determined.

The status generation module 1101 and the action generation module 1102 are further configured to use the target to-be-recommended object and the user behavior for the target to-be-recommended object as historical data to determine a next to-be-recommended object.

It should be noted that the foregoing units (the status generation module 1101, the status generation module 1102, the training module 1103, and the obtaining module 1104) are configured to perform related content of the method shown in steps S201 to S203.

In this embodiment, the recommendation apparatus 1100 is presented in a form of a unit. The “unit” herein may be an application-specific integrated circuit (application-specific integrated circuit, ASIC), a processor and memory for executing one or more software or firmware programs, an integrated logic circuit, and/or another device that can provide the foregoing functions. In addition, the status generation module 1101, the status generation module 1102, the training module 1103, and the obtaining module 1104 may be implemented by using a processor 1201 of a recommendation apparatus shown in FIG. 12.

The recommendation apparatus or a training apparatus shown in FIG. 12 may be implemented by using a structure in FIG. 12. The recommendation apparatus or the training apparatus includes at least one processor 1201, at least one memory 1202, and at least one communications interface 1203. The processor 1201, the memory 1202, and the communications interface 1203 are connected and communicate with each other by using a communications bus.

The communications interface 1203 is configured to communicate with another device or a communications network, for example, the Ethernet, a radio access network (radio access network, RAN), or a wireless local area network (wireless local area networks, WLAN).

The memory 1202 may be a read-only memory (read-only memory, ROM) or another type of static storage device that can store static information and an instruction, or a random access memory (random access memory, RAM) or another type of dynamic storage device that can store information and an instruction, or may be an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be used to carry or store expected program code in a form of an instruction or a data structure and that can be accessed by a computer. However, the memory 1202 is not limited thereto. The memory may exist independently, and may be connected to the processor by using the bus. The memory may alternatively be integrated with the processor.

The memory 1202 is configured to store application program code for executing the foregoing solution, and the processor 1201 controls the execution. The processor 1201 is configured to execute the application program code stored in the memory 1202.

The code stored in the memory 1202 may be used to perform the foregoing provided recommendation method or model training method.

The processor 1201 may further use one or more integrated circuits to execute a related program, so as to implement the recommendation method or the model training method in the embodiments of this application.

The processor 1201 may alternatively be an integrated circuit chip and has a signal processing capability. In an implementation process, steps of the recommendation method in this application may be completed by using an integrated logic circuit of hardware in the processor 1201 or an instruction in a form of software. In an implementation process, steps of the method for training the status generation model and the selection policy in this application may be completed by using the integrated logic circuit of the hardware in the processor 1201 or the instruction in the form of software. The processor 1201 may alternatively be a general-purpose processor, a digital signal processor (digital signal processing, DSP), an ASIC, a field programmable gate array (field programmable gate array, FPGA) or another programmable logic device, a discrete gate or transistor logic device, or a discrete hardware component, and can implement or perform the methods, the steps, and the module block diagrams disclosed in the embodiments of this application. The general-purpose processor may be a microprocessor, or the processor may be any conventional processor or the like. Steps of the methods disclosed with reference to the embodiments of this application may be directly implemented by using a hardware decoding processor, or may be implemented by using a combination of hardware in a decoding processor and a software module. The software module may be located in a mature storage medium in the art, such as a random access memory, a flash memory, a read-only memory, a programmable read-only memory, an electrically erasable programmable memory, or a register. The storage medium is located in the memory 1202. The processor 1201 reads information in the memory 1202, and implements the recommendation method or the model training method in the embodiments of this application in combination with the hardware in the processor 1201.

The communications interface 1203 uses a transceiver apparatus, such as but not limited to a transceiver, to implement communication between the recommendation apparatus or the training apparatus and another device or a communications network. For example, recommendation-related data (a historical recommended object and a user behavior for each historical recommended object) or training data may be obtained through the communications interface 1203.

The bus may include a path for information transfer between components (for example, the memory 1202, the processor 1201, and the communications interface 1203) of the apparatus.

In a possible embodiment, the processor 1201 specifically performs the following steps:

obtaining a recommendation system status parameter based on a plurality of historical recommended objects and a user behavior for each historical recommended object; determining a target set in lower-level sets from the lower-level sets based on the recommendation system status parameter and according to a selection policy corresponding to an upper-level set, where the upper-level set and the lower-level sets are obtained by performing hierarchical clustering on a plurality of to-be-recommended objects, the hierarchical clustering is grouping the to-be-recommended objects into a plurality of levels of sets, and the upper-level set includes a plurality of level-2 sets; and determining a target to-be-recommended object from the target set.

When performing the step of obtaining a recommendation system status parameter based on a plurality of historical recommended objects and a user behavior for each historical recommended object, the processor 1201 specifically performs the following steps:

determining a reward value of each historical recommended object based on the user behavior for the historical recommended object; and inputting the plurality of historical recommended objects and reward values of the plurality of historical recommended objects into a status generation model, to obtain the recommendation system status parameter, where the status generation model is a recurrent neural network model.

In a possible embodiment, the target set in the lower-level sets corresponds to one selection policy, the target set in the lower-level sets includes a plurality of subsets, the subset is a lower-level set of the target set, and when performing the step of determining a target to-be-recommended object from the target set, the processor 1201 specifically performs the following steps:

selecting, based on the recommendation system status parameter and according to the selection policy corresponding to the target set, a target subset from the plurality of subsets included in the target set; and determining the target to-be-recommended object from the target subset.

In a possible embodiment, each lower-level set corresponds to one selection policy, and when performing the step of determining a target to-be-recommended object from the target set, the processor 1201 specifically performs the following step:

selecting the target to-be-recommended object from the target set according to a selection policy corresponding to the target set and based on the recommendation system status parameter.

In a possible embodiment, the performing hierarchical clustering on a plurality of to-be-recommended objects includes: performing hierarchical clustering on the plurality of to-be-recommended objects by constructing a balanced clustering tree.

In a possible embodiment, the selection policy is a fully connected neural network model.

In a possible embodiment, the selection policy and the status generation model are obtained through machine learning and training, and training sample data is (s₁, a₁, r₁, s₂, a₂, r₂, . . . , sₜ, aₜ, rₜ), where (a₁, a₂, . . . , aₜ) are historical recommended objects; r₁, r₂, . . . , and rₜ are reward values obtained through calculation based on user behaviors for the historical recommended objects (a₁, a₂, . . . , aₜ), respectively; and (s₁, s₂, . . . , sₜ) are historical recommendation system status parameters.

In a possible embodiment, the processor 1201 further performs the following steps:

after determining the target to-be-recommended object from the target set, obtaining a user behavior for the target to-be-recommended object; and using the target to-be-recommended object and the user behavior for the target to-be-recommended object as historical data to determine a next to-be-recommended object.

An embodiment of the present invention provides a computer storage medium. The computer storage medium stores a computer program. The computer program includes a program instruction. When the program instruction is executed by a processor, the processor is enabled to perform some or all steps of any recommendation method described in the foregoing method embodiments.

It should be noted that, for brevity of description, each of the foregoing method embodiments is described as a series of actions. However, a person skilled in the art should appreciate that the present invention is not limited to the described action sequence, because according to the present invention, some steps may be performed in another sequence or simultaneously. In addition, a person skilled in the art should also appreciate that all the embodiments described in this specification are preferred embodiments, and related actions and modules are not necessarily mandatory to the present invention.

In the foregoing embodiments, descriptions of each embodiment have a focus. For a part that is not described in detail in an embodiment, refer to related descriptions in another embodiment.

In the several embodiments provided in this application, it should be understood that the disclosed apparatus may be implemented in another manner. For example, the described apparatus embodiment is merely an example. For example, division into the units is merely logical function division and may be other division in actual implementation. For example, a plurality of units or components may be combined or may be integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical or other forms.

The units described as separate parts may or may not be physically separate, and parts displayed as units may or may not be physical units, may be located in one position, or may be distributed on a plurality of network units. Some or all of the units may be selected based on an actual requirement to achieve the objectives of the solutions in the embodiments.

In addition, the functional units in the embodiments of the present invention may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable memory. Based on such an understanding, the technical solutions of the present invention essentially, or the part contributing to the prior art, or all or some of the technical solutions may be implemented in a form of a software product. The computer software product is stored in a memory and includes several instructions for instructing a computer device (which may be a personal computer, a server, a network device, or the like) to perform all or some of the steps of the methods described in the embodiments of the present invention. The foregoing memory includes any medium that can store program code, such as a USB flash drive, a ROM, a RAM, a removable hard disk, a magnetic disk, or an optical disc.

A person of ordinary skill in the art may understand that all or some of the steps of the methods in the embodiments may be implemented by a program instructing relevant hardware. The program may be stored in a computer-readable memory. The memory may include: a flash memory, a ROM, a RAM, a magnetic disk, an optical disc, or the like.

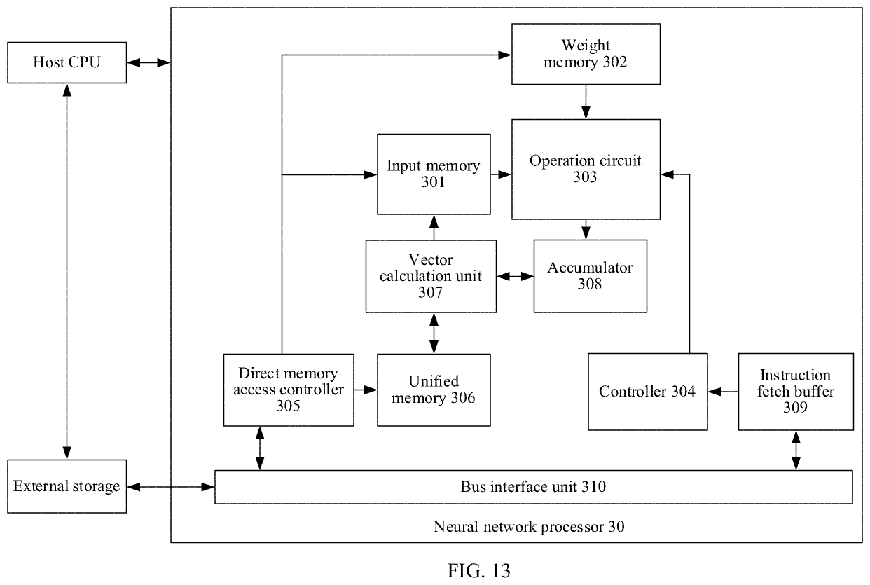

In addition to the hardware structure shown in FIG. 12, FIG. 13 shows another hardware structure of a chip according to an embodiment of the present invention. The chip includes a neural network processor 30. The chip may be disposed in the execution device 110 shown in FIG. 1, to implement calculation work of the calculation module 111. Alternatively, the chip may be disposed in the training device 120 shown in FIG. 1, to implement training work of the training device 120 and output the status generation model/selection policy 101.

The neural network processor 30 may be any processor suitable for large-scale exclusive OR operation processing, such as an NPU, a high-performance processor (tensor processing unit, TPU), or a GPU. The NPU is used as an example. The NPU may be mounted to a host CPU (Host CPU) as a coprocessor, and the host CPU allocates a task to the NPU. A core part of the NPU is an operation circuit 303. The operation circuit 303 is controlled by a controller 304 to extract matrix data in memories (301 and 302) and perform a multiply-add operation.

In some implementations, the operation circuit 303 internally includes a plurality of processing engines (process engine, PE). In some implementations, the operation circuit 303 is a two-dimensional systolic array. The operation circuit 303 may alternatively be a one-dimensional systolic array or another electronic circuit that can perform mathematical operations such as multiplication and addition. In some implementations, the operation circuit 303 is a general-purpose matrix processor.

For example, it is assumed that there are an input matrix A, a weight matrix B, and an output matrix C. The operation circuit 303 obtains weight data of the matrix B from a weight memory 302, and buffers the weight data on each PE in the operation circuit 303. The operation circuit 303 obtains input data of the matrix A from an input memory 301, performs a matrix operation based on the input data of the matrix A and the weight data of the matrix B, to obtain a partial result or a final result of the matrix, and stores the partial result or the final result into an accumulator (accumulator) 308.

A unified memory 306 is configured to store the input data and output data. The weight data is directly moved to the weight memory 302 by using a direct memory access controller (direct memory access controller, DMAC) 305. The input data is also moved to the unified memory 306 by using the DMAC.

A bus interface unit (bus interface unit, BIU) 310 is used for interaction between the DMAC and an instruction fetch buffer (instruction fetch buffer) 309. The bus interface unit 301 is further configured to support the instruction fetch buffer 309 in obtaining an instruction from an external storage. The bus interface unit 301 is further configured to support the direct memory access controller 305 in obtaining original data of the input matrix A or the weight matrix B from the external storage.

The DMAC is mainly configured to: move the input data in the external storage such as DDR to the unified memory 306, or move the weight data to the weight memory 302, or move the input data to the input memory 301.

A vector calculation unit 307 includes a plurality of operation processing units, and if required, performs further processing such as vector multiplication, vector addition, an exponential operation, a logarithmic operation, or value comparison on an output of the operation circuit 303. The vector calculation unit 307 is mainly configured to perform calculation at a non-convolutional layer or a fully connected (fully connected, FC) layer in a neural network, and may specifically process calculation such as pooling (Pooling) and normalization (Normalization). For example, the vector calculation unit 307 may apply anon-linear function to the output of the operation circuit 303, such as a vector of an accumulated value, to generate an active value. In some implementations, the vector calculation unit 307 generates a normalized value, or a combined value, or both a normalized value and a combined value.

In some implementations, the vector calculation unit 307 stores a processed vector into the unified memory 306. In some implementations, a vector processed by the vector calculation unit 307 can be used as an active input of the operation circuit 303. The instruction fetch buffer (instruction fetch buffer) 309 connected to the controller 304 is configured to store an instruction used by the controller 304.

The unified memory 306, the input memory 301, the weight memory 302, and the instruction fetch buffer 309 are all on-chip (On-Chip) memories. The external storage is independent of the NPU hardware architecture.

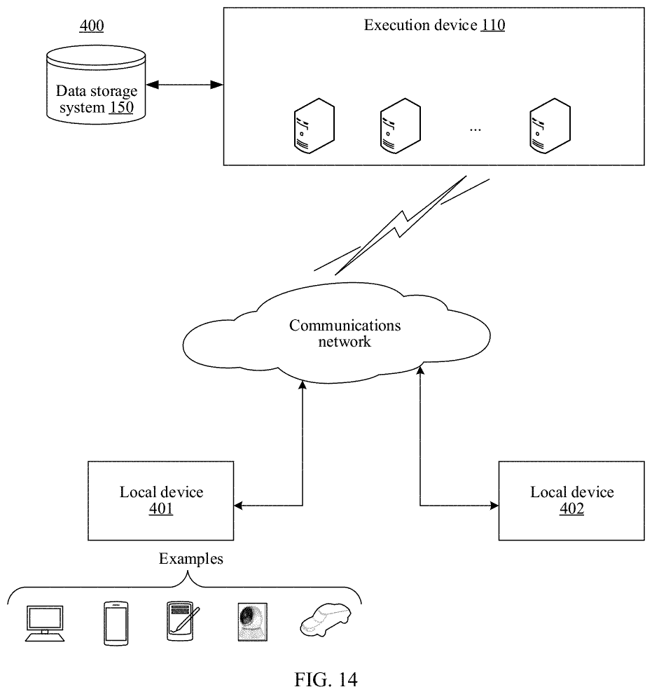

In a possible embodiment, referring to FIG. 14, an embodiment of the present invention provides a system architecture 400. An execution device 110 is implemented by one or more servers. Optionally, the execution device 110 cooperates with another computing device, for example, a device such as a data storage device, a router, or a load balancer. The execution devices 110 may be disposed on one physical site, or distributed on a plurality of physical sites. The execution device 110 may use data in a data storage system 150 or invoke program code in a data storage system 150 to obtain a status generation model, and train the status generation model and a selection policy, and determine a target to-be-recommended object (including the foregoing application, movie, information, or the like) based on the status generation model and the selection policy.

Specifically, the execution device 110 obtains a plurality of historical recommended objects and a user behavior for each historical recommended object; determines a reward value of each historical recommended object based on the user behavior for the historical recommended object; inputs the plurality of historical recommended objects and reward values of the plurality of historical recommended objects into the status generation model, to obtain a recommendation system status parameter; determines a target set from lower-level sets based on the recommendation system status parameter and according to a selection policy corresponding to an upper-level set; and determines a target to-be-recommended object from the target set, or determines a target subset from a plurality of subsets in the target set and then determines a target to-be-recommended object from the target subset.

Each user may operate user equipment (for example, a local device 401 or a local device 402) of the user to interact with the execution device 110. For example, the execution device 110 recommends the target to-be-recommended object to the user equipment, and then the user views the target to-be-recommended object by operating the user equipment of the user, and feeds back a user behavior to the execution device 110, to help the execution device 110 perform next recommendation. Each local device may be any computing device, such as a personal computer, a computer workstation, a smartphone, a tablet computer, an intelligent camera, a smart automobile, or another type of cellular phone, a media consumption device, a wearable device, a set-top box, or a game console.

A local device of each user may interact with the execution device 110 through a communications network of any communication mechanism/communications standard. The communications network may be in a form such as a wide area network, a local area network, or a point-to-point connection, or any combination thereof.

In another implementation, one or more aspects of the execution device 110 may be implemented by each local device. For example, the local device 401 may provide local data for the execution device 110 or feed back a calculation result to the execution device 110, for example, a historical recommended object and a user behavior for the historical recommended object.

It should be noted that the local device may alternatively implement all functions of the execution device 110. For example, the local device 401 implements the functions of the execution device 110, and provides a service for a user of the local device 401 or provides a service for a user of the local device 402. For example, the local device 401 obtains a plurality of historical recommended objects and a user behavior for each historical recommended object; determines a reward value of each historical recommended object based on the user behavior for the historical recommended object; inputs the plurality of historical recommended objects and reward values of the plurality of historical recommended objects into the status generation model, to obtain a recommendation system status parameter; determines a target set from lower-level sets based on the recommendation system status parameter and according to a selection policy corresponding to an upper-level set; and determines a target to-be-recommended object from the target set, or determines a target subset from a plurality of subsets in the target set and then determines a target to-be-recommended object from the target subset. Finally, the local device 401 recommends the target to-be-recommended object to the local device 402, and receives a user behavior for the target to-be-recommended object, for next recommendation.

The embodiments of the present invention are described in detail above. The principle and implementations of the present invention are described in this specification by using specific examples. The foregoing descriptions of the embodiments are merely intended to help understand the method and core ideas of the present invention. In addition, a person of ordinary skill in the art can make variations to the present invention in terms of specific implementations and application scopes according to the ideas of the present invention. Therefore, content of this specification shall not be construed as a limitation on the present invention.

What is claimed is:

1. A recommendation-providing method executed by one or more processors, comprising:
determining, for each of a plurality of historical recommended objects, a reward value of said each historical recommended object based on a user behavior for said each historical recommended object;
inputting the plurality of historical recommended objects and reward values of the plurality of historical recommended objects into a status generation model to obtain a recommendation system status parameter, wherein the status generation model is a recurrent neural network model;
determining a target set from a plurality of lower-level sets according to the recommendation system status parameter and a selection policy corresponding to an upper-level set, wherein the upper-level set corresponds to an upper-level node of a clustering tree representing to-be-recommended objects, the plurality of lower-level sets corresponds to lower-level nodes of the clustering tree under the upper-level node, the upper-level set comprises the plurality of lower-level sets, and each lower-level set comprises a plurality of to-be-recommended objects; and
determining a target to-be-recommended object from to-be-recommended objects of the target set.

2. The method according to claim 1, wherein the target set in the lower-level sets corresponds to one selection policy, the target set in the lower-level sets comprises a plurality of subsets, the subset is a lower-level set of the target set which belongs to the clustering tree, and wherein the step of determining the target to-be-recommended object comprises:
selecting, based on the recommendation system status parameter and according to the selection policy corresponding to the target set, a target subset from the plurality of subsets comprised in the target set; and
determining the target to-be-recommended object from the target subset.

3. The method according to claim 1, wherein each lower-level set corresponds to one selection policy, and wherein the step of determining the target to-be-recommended object comprises:
selecting the target to-be-recommended object from the target set according to a selection policy corresponding to the target set and based on the recommendation system status parameter.

4. The method according to claim 1, further comprising:
performing hierarchical clustering on a group of to-be-recommended objects to construct the clustering tree, wherein the clustering tree is a balanced clustering tree.

5. The method according to claim 1, wherein the selection policy is a fully connected neural network model.

6. The method according to claim 1, wherein the selection policy and the status generation model are obtained through machine learning and training, and training sample data is (s1, a1, r1, s2, a2, r2, . . . , st, at, rt), wherein (a1, a2, . . . , at) are historical recommended objects; r1, r2, . . . , and rt are reward values obtained through calculation based on user behaviors for the historical recommended objects (a1, a2, . . . , at), respectively, and (s1, s2, . . . , st) are historical recommendation system status parameters.

7. The method according to claim 1, wherein after determining the target to-be-recommended object, the method further comprises:
obtaining a user behavior for the target to-be-recommended object; and
using the target to-be-recommended object and the user behavior for the target to-be-recommended object as historical data to determine a next to-be-recommended object.

8. A recommendation apparatus, comprising:
a memory storing executable instructions; and
a processor coupled to the memory and configured to execute the executable instructions to perform operations of:
determining, for each of a plurality of historical recommended objects, a reward value of said each historical recommended object based on a user behavior for said each historical recommended object;
inputting the plurality of historical recommended objects and reward values of the plurality of historical recommended objects into a status generation model to obtain a recommendation system status parameter, wherein the status generation model is a recurrent neural network model;
determining a target set from a plurality of lower-level sets according to the recommendation system status parameter and a selection policy corresponding to an upper-level set, wherein the upper-level set corresponds to an upper-level node of a clustering tree representing to-be-recommended objects, the plurality of lower-level sets corresponds to lower-level nodes of the clustering tree under the upper-level node, the upper-level set comprises the plurality of lower-level sets, and each lower-level set comprises a plurality of to-be-recommended objects; and
determining a target to-be-recommended object from to-be-recommended objects of the target set.

9. The recommendation apparatus according to claim 8, wherein the target set in the lower-level sets corresponds to one selection policy, the target set in the lower-level sets comprises a plurality of subsets, the subset is a lower-level set of the target set which belongs to the clustering tree, and wherein the operation of determining a target to-be-recommended object comprises:
selecting, based on the recommendation system status parameter and according to the selection policy corresponding to the target set, a target subset from the plurality of subsets comprised in the target set; and
determining the target to-be-recommended object from the target subset.

10. The recommendation apparatus according to claim 8, wherein each lower-level set corresponds to one selection policy, and wherein the operation of determining a target to-be-recommended object comprises:
selecting the target to-be-recommended object from the target set according to a selection policy corresponding to the target set and based on the recommendation system status parameter.

11. The recommendation apparatus according to claim 8, wherein the processor is configured to further perform an operation of:
performing hierarchical clustering on a group of to-be-recommended objects to construct the clustering tree, wherein the clustering tree is a balanced clustering tree.

12. The recommendation apparatus according to claim 8, wherein the selection policy is a fully connected neural network model.

13. The recommendation apparatus according to claim 8, wherein the selection policy and the status generation model are obtained through machine learning and training, and training sample data is (s1, a1, r1, s2, a2, r2, . . . , st, at, rt), wherein (a1, a2, . . . , at) are historical recommended objects; r1, r2, . . . , and rt are reward values obtained through calculation based on user behaviors for the historical recommended objects (al, a2, . . . , at), respectively, and (s1, s2, . . . , st) are historical recommendation system status parameters.

14. The recommendation apparatus according to claim 8, wherein after determining the target to-be-recommended object, the processor is configured to further perform operations of:
obtaining a user behavior for the target to-be-recommended object; and
using the target to-be-recommended object and the user behavior for the target to-be-recommended object as historical data to determine a next to-be-recommended object.

15. A non-transitory computer storage medium having stored thereon computer-executable instructions that when executed by a processor of an apparatus cause the apparatus to perform operations of:
determining, for each of a plurality of historical recommended objects, a reward value of said each historical recommended object based on a user behavior for said each historical recommended object;
inputting the plurality of historical recommended objects and reward values of the plurality of historical recommended objects into a status generation model to obtain a recommendation system status parameter, wherein the status generation model is a recurrent neural network model;
determining a target set from a plurality of lower-level sets according to the recommendation system status parameter and a selection policy corresponding to an upper-level set, wherein the upper-level set corresponds to an upper-level node of a clustering tree representing to-be-recommended objects, the plurality of lower-level sets corresponds to lower-level nodes of the clustering tree under the upper-level node, the upper-level set comprises the plurality of lower-level sets, and each lower-level set comprises a plurality of to-be-recommended objects; and
determining a target to-be-recommended object from the target set.

16. The computer storage medium according to claim 15, wherein the target set in the lower-level sets corresponds to one selection policy, the target set in the lower-level sets comprises a plurality of subsets, the subset is a lower-level set of the target set which belongs to the clustering tree, and wherein the operation of determining a target to-be-recommended object comprises:
selecting, based on the recommendation system status parameter and according to the selection policy corresponding to the target set, a target subset from the plurality of subsets comprised in the target set; and
determining the target to-be-recommended object from the target subset.

17. The computer storage medium according to claim 15, wherein each lower-level set corresponds to one selection policy, and wherein the operation of determining the target to-be-recommended object comprises:
selecting the target to-be-recommended object from the target set according to a selection policy corresponding to the target set and based on the recommendation system status parameter.
